(19) United States
(12) Patent Application Publication
(10) Pub. No.: US 2026/0259913 A1
(43) Pub. Date: Sep. 3, 2026

(54) Federated Geometric Intrusion Detection and Mitigation for Persistent Cognitive Machines

(71) Applicant: AtomBeam Technologies Inc., Moraga, CA (US)

(72) Inventor: Brian Galvin, Silverdale, WA (US)

(21) Appl. No.: 19/563,169

(22) Filed: Mar. 11, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/382,207, filed on Nov. 6, 2025.
Application No. 19/382,207 is a continuation of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 16/334; G06F 11/1446; G06F 16/3329; G06F 16/353; G06F 18/2137; G06N 3/049; G06N 3/06

(52) U.S. Cl. CPC G06F 16/3347; G06F 11/1446; G06F 16/3329; G06F 16/353; G06F 18/21375; G06N 3/049; G06N 3/061

(57) ABSTRACT

A system and method for detecting, mitigating, and learning from adversarial geometric influence on the persistent cognitive structure of one or more persistent cognitive machines. Intrusion is defined as epistemically illegitimate structural influence on the cognitive manifold and is detected by continuously evaluating epistemic phase, holonomy integrity, curvature distribution, representational capacity, and reservoir boundary dynamics against admissible geometric regimes. Detected intrusions trigger graduated mitigation through geometric quarantine, admission control tightening, capacity hardening, reservoir boundary reinforcement, and intrusion-aware output gating. Structural immunity is acquired by projecting non-invertible, content-agnostic geometric constraints into non-navigable storage structurally separated from the task learning substrate, such that security learning cannot contaminate task knowledge. In multi-node deployments, nodes share aggregated geometric invariants through a federated coordination channel, enabling detection of cross-node epistemic desynchronization and distribution of elevated structural immunity constraints without exposing cognitive content, model parameters, or reasoning trajectories of any participating node.

### CROSS-REFERENCE TO RELATED APPLICATIONS

Priority is claimed in the application data sheet to the following patents or patent applications, each of which is expressly incorporated herein by reference in its entirety:
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
Ser. No. 19/382,207
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention is in the field of security architectures for persistent artificial intelligence systems, and more particularly to systems and methods for detecting, mitigating, and learning from adversarial geometric influence on the epistemic manifold structure of persistent cognitive machines operating in both single-node and federated multi-node deployments.

### Discussion of the State of the Art

Existing approaches to intrusion detection and adversarial defense in artificial intelligence systems fail along a common axis: they treat security-relevant state as ephemeral and confine detection to the level of individual inputs, outputs, or behavioral statistics. Conventional intrusion detection systems compare observed data against predefined rules or learned statistical baselines, providing no mechanism for detecting adversarial influence that accumulates gradually across interactions, remains statistically unremarkable at the data level, or targets the long-lived internal structure of a learning system. Adversarial machine learning defenses—including adversarial training, certified robustness techniques, and ensemble verification methods—are designed for stateless or near-stateless inference systems in which model parameters are fixed at deployment and threats are bounded by individual inference queries. They provide no framework for detecting or mitigating adversarial influence on internal cognitive structure that evolves continuously through use. Adversarial training approaches introduce a further structural defect: they require adversarial content to be processed by the same learning substrate that performs task learning, providing no structural guarantee that security learning and task learning are separated or that adversarial content cannot contaminate task knowledge. Federated learning and multi-agent security architectures require the sharing of model gradients, parameter updates, or learned representations across nodes, creating information leakage and model inversion risks, and providing no mechanism for detecting the class of coordinated attacks that are visible only through cross-node geometric comparison while remaining locally unremarkable at each individual node. Prompt injection defenses and output filtering approaches address adversarial influence at the semantic or behavioral level and are incapable of detecting adversarial influence that deforms internal cognitive structure without producing detectable semantic anomalies in any individual input or output.

What is needed is an intrusion detection and mitigation architecture that operates at the level of the persistent geometric structure of cognitive systems; that detects adversarial influence by evaluating whether the epistemic manifold of a persistent cognitive machine remains within admissible geometric regimes during operation, without reference to prior knowledge of specific attack strategies; that acquires durable structural immunity from adversarial experience through non-invertible, content-agnostic geometric constraints stored in a form structurally separated from the task learning substrate; and that, in multi-node deployments, enables coordinated detection of attack classes invisible to any individual node by sharing only aggregated geometric invariants that expose no cognitive content, model internals, or reasoning trajectories of any participating node.

### SUMMARY OF THE INVENTION

Accordingly, the inventor has conceived and reduced to practice, a system and method for detecting, mitigating, and learning from adversarial geometric influence on the persistent cognitive structure of one or more persistent cognitive machines. Intrusion is defined as epistemically illegitimate structural influence on the cognitive manifold and is detected by continuously evaluating epistemic phase, holonomy integrity, curvature distribution, representational capacity, and reservoir boundary dynamics against admissible geometric regimes. Detected intrusions trigger graduated mitigation through geometric quarantine, admission control tightening, capacity hardening, reservoir boundary reinforcement, and intrusion-aware output gating. Structural immunity is acquired by projecting non-invertible, content-agnostic geometric constraints into non-navigable storage structurally separated from the task learning substrate, such that security learning cannot contaminate task knowledge. In multi-node deployments, nodes share aggregated geometric invariants through a federated coordination channel, enabling detection of cross-node epistemic desynchronization and distribution of elevated structural immunity constraints without exposing cognitive content, model parameters, or reasoning trajectories of any participating node.

According to a preferred embodiment, a computer-implemented system for detecting and mitigating adversarial geometric influence on a persistent cognitive machine is disclosed, comprising a processor and a memory storing instructions that, when executed by the processor, cause the system to: maintain a cognitive substrate comprising a structured geometric space whose geometry persists across interactions and is reshaped by accumulated experience; evaluate, without reference to semantic content or input payload, a plurality of geometric indicators of the cognitive substrate to produce a composite assessment of whether the geometric structure of the cognitive substrate remains within admissible epistemic regimes; issue an intrusion determination when the composite assessment satisfies a detection threshold, the intrusion determination classifying detected adversarial influence by geometric attack type; apply, upon issuance of the intrusion determination, one or more geometric mitigation controls to affected regions of the cognitive substrate, wherein regions of the cognitive substrate not implicated in the detected adversarial influence continue normal operation throughout the mitigation period; generate an intrusion signature encoding a structural characterization of the detected adversarial influence, wherein generating the intrusion signature does not incorporate semantic content of any input associated with the detected adversarial influence and wherein the intrusion signature is stored in a form that cannot be accessed by or incorporated into the task learning operations of the cognitive substrate; and emit active admissibility constraints derived from the intrusion signature that restrict future cognitive trajectory selection in the cognitive substrate, wherein the emitted constraints persist independently of the mitigation controls applied upon issuance of the intrusion determination and accumulate across successive adversarial interactions such that structural immunity of the cognitive substrate against recurring geometric attack classes increases over the operational lifetime of the system.

According to another preferred embodiment, a computer-implemented method for detecting and mitigating adversarial geometric influence on a persistent cognitive machine, the method comprising the steps of: maintaining a cognitive substrate comprising a structured geometric space whose geometry persists across interactions and is reshaped by accumulated experience; evaluating, without reference to semantic content or input payload, a plurality of geometric indicators of the cognitive substrate to produce a composite assessment of whether the geometric structure of the cognitive substrate remains within admissible epistemic regimes; issuing an intrusion determination when the composite assessment satisfies a detection threshold, the intrusion determination classifying detected adversarial influence by geometric attack type; applying, upon issuance of the intrusion determination, one or more geometric mitigation controls to affected regions of the cognitive substrate, wherein regions of the cognitive substrate not implicated in the detected adversarial influence continue normal operation throughout the mitigation period; generating an intrusion signature encoding a structural characterization of the detected adversarial influence, wherein generating the intrusion signature does not incorporate semantic content of any input associated with the detected adversarial influence and wherein the intrusion signature is stored in a form that cannot be accessed by or incorporated into the task learning operations of the cognitive substrate; and emitting active admissibility constraints derived from the intrusion signature that restrict future cognitive trajectory selection in the cognitive substrate, wherein the emitted constraints persist independently of the mitigation controls applied upon issuance of the intrusion determination and accumulate across successive adversarial interactions such that structural immunity of the cognitive substrate against recurring geometric attack classes increases over the operational lifetime of the system.

According to a further aspect, the method includes the cognitive substrate decomposed into an active sector in which traversal and revisable adaptation occur, an irreversible sector comprising one or more irreversible reservoirs encoding durable knowledge, and a boundary sector mediating curvature exchange between the active sector and the irreversible sector, and wherein total curvature energy across the active sector, boundary sector, and irreversible sector changes only in response to externally introduced experience.

According to a further aspect, the method includes the plurality of geometric indicators comprising epistemic phase accumulation along cognitive trajectories, holonomy integrity of path-dependent experiential structure, curvature distribution and structural imbalance across regions of the cognitive substrate, representational capacity utilization relative to intrinsic geometric limits of the cognitive substrate, and reservoir boundary stress at boundaries of one or more irreversible reservoirs of the cognitive substrate.

According to a further aspect, the method includes evaluating the plurality of geometric indicators comprising one or more of: correlating signals across the plurality of geometric indicators, evaluating persistence of anomalous indicator values over successive monitoring cycles, and comparing current indicator values against established baseline envelopes, and wherein the detection threshold requires anomalous values in a plurality of indicators assessed together, such that no single indicator value alone is sufficient to satisfy the detection threshold.

According to a further aspect, the method includes generating the intrusion signature comprising one or more of: discarding all semantic content associated with the adversarial interaction, encoding a structural cause of the detected adversarial influence as a content-agnostic geometric representation, applying a non-invertible compression operation to the geometric representation such that the original structural cause cannot be recovered from the compressed form, and projecting the compressed representation into non-navigable storage through a non-invertible projection operation, wherein the projected intrusion signature cannot be traversed, replayed, or reconstructed into active cognition.

According to a further aspect, the method includes generating the intrusion signature conditioned on the detected adversarial influence satisfying a persistence threshold requiring that anomalous geometric indicators underlying the intrusion determination have been present continuously over a minimum structural period, such that transient geometric stress events that satisfy the detection threshold do not produce intrusion signatures.

According to a further aspect, the method includes one or more geometric mitigation controls comprising one or more of: restricting cognitive trajectory traversal into or through geometrically compromised regions and suspending consolidation of representations in affected regions; tightening admission criteria for new representations entering the cognitive substrate in respects corresponding to the geometric attack type of the intrusion determination; hardening representational capacity limits to resist forced over-compression in affected regions; reinforcing boundary energy at boundaries of affected irreversible reservoirs and strengthening corroboration requirements for boundary-crossing events in affected regions; and suppressing or qualifying outputs derived from geometrically compromised regions and signaling elevated epistemic uncertainty in outputs derived from regions adjacent to affected regions.

According to a further aspect, the method includes monitoring geometric indicators of the cognitive substrate following application of the one or more geometric mitigation controls, and upon sustained return of the geometric indicators to within-envelope conditions, gradually relaxing the one or more geometric mitigation controls in stages with monitoring between stages, re-engaging the one or more geometric mitigation controls at a prior intensity level if geometric indicators exceed within-envelope conditions during relaxation, wherein the active admissibility constraints emitted from the intrusion signature remain in force throughout and after the relaxation of the mitigation controls.

According to a further aspect, the method includes transmitting, to one or more peer systems each maintaining a respective cognitive substrate, aggregated geometric invariant summaries derived from the plurality of geometric indicators, wherein the aggregated geometric invariant summaries do not include semantic content, cognitive trajectory detail, manifold coordinates, or model parameters of the cognitive substrate; receiving aggregated geometric invariant summaries from the one or more peer systems and incorporating the received summaries into the composite assessment as a cross-node divergence signal, wherein divergence of the geometric indicators of the cognitive substrate from peer-system baselines is sufficient to satisfy the detection threshold independent of whether any single-node indicator independently satisfies the detection threshold; and, upon peer confirmation that the intrusion signature corresponds to a geometric attack class confirmed by a threshold number of peer systems, distributing the intrusion signature as an elevated admissibility constraint to the one or more peer systems without transmitting the structural characterization underlying the intrusion signature.

According to a further aspect, the method includes the active admissibility constraints emitted from the intrusion signature evolve over the operational lifetime of the system such that repeated confirmation of the same geometric attack class strengthens the influence of the emitted constraints, the influence of the emitted constraints diminishes in the absence of corroborating adversarial activity over a decay period, and the emitted constraints are subject to controlled relaxation upon satisfaction of geometric and temporal stability criteria without requiring external intervention.

### BRIEF DESCRIPTION OF THE DRAWING FIGURES

FIG. 1 is a block diagram illustrating an exemplary system architecture for a federated geometric intrusion detection system, according to an embodiment.

FIG. 2 is a block diagram illustrating an exemplary embodiment of geometric intrusion detection module.

FIG. 3 is a block diagram illustrating an exemplary embodiment of the epistemic intrusion signature store.

FIG. 4 is a block diagram illustrating an exemplary embodiment of a geometric control and mitigation engine.

FIG. 5 is a flow diagram of an exemplary method of detecting a geometric intrusion in a single PCM node, according to an embodiment.

FIG. 6 is a flow diagram of an exemplary method for federated geometric intrusion detection across a multi-node federation of persistent cognitive machines, according to an embodiment.

FIG. 7 is a flow diagram of an exemplary method of learning from intrusion without content poisoning, according to an embodiment.

FIG. 8 is a flow diagram of an exemplary method of intrusion response and recovery, according to an embodiment.

FIG. 9 illustrates an exemplary computing environment on which an embodiment described herein may be implemented.

### DETAILED DESCRIPTION OF THE INVENTION

The inventor has conceived, and reduced to practice, a system and method for detecting, mitigating, and learning from adversarial geometric influence on the persistent cognitive structure of one or more persistent cognitive machines. Intrusion is defined as epistemically illegitimate structural influence on the cognitive manifold and is detected by continuously evaluating epistemic phase, holonomy integrity, curvature distribution, representational capacity, and reservoir boundary dynamics against admissible geometric regimes. Detected intrusions trigger graduated mitigation through geometric quarantine, admission control tightening, capacity hardening, reservoir boundary reinforcement, and intrusion-aware output gating. Structural immunity is acquired by projecting non-invertible, content-agnostic geometric constraints into non-navigable storage structurally separated from the task learning substrate, such that security learning cannot contaminate task knowledge. In multi-node deployments, nodes share aggregated geometric invariants through a federated coordination channel, enabling detection of cross-node epistemic desynchronization and distribution of elevated structural immunity constraints without exposing cognitive content, model parameters, or reasoning trajectories of any participating node.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Accessibility” as used herein means a property of a region, representation, or trajectory within a cognitive substrate indicating whether said region, representation, or trajectory can be reached, traversed, or modified during a processing cycle under current geometric structure and control policies, wherein accessibility is determined by accumulated irreversible constraints and local geometric structure rather than by presence in storage, and wherein accessibility may change irreversibly as the substrate evolves.

“Active sector” as used herein means the portion of a cognitive substrate in which reasoning, traversal, and revisable adaptation occur, carrying the full complement of geometric structures with generally nonzero epistemic curvature, and defined as the complement of the irreversible sector and the boundary sector within said substrate.

“Admissible deformation” as used herein means a continuous family of cognitive trajectories connecting two trajectories having identical endpoints, wherein every intermediate trajectory in said family satisfies the system's admissibility constraints, such that the two trajectories are interchangeable for purposes of global reasoning without passing through incoherent, contradictory, or otherwise inadmissible regions of the cognitive substrate.

“Barrier energy” as used herein means an energetic quantity concentrated at the boundary of an irreversible reservoir, arising from the accumulation of curvature exported during consolidation, wherein said barrier energy determines the cost of externally modifying the reservoir's consolidated content and provides the admission-control mechanism governing curvature exchange between the active sector and the irreversible sector.

“Boundary event” as used herein means an interaction at the boundary of an irreversible reservoir, classified by the character of the incoming curvature into one or more of: (a) corroboration, in which the incoming evidence is compatible with consolidated content and is absorbed; (b) novelty, in which the evidence extends but does not contradict consolidated content; (c) contradiction, in which the evidence conflicts with consolidated content; or (d) ambiguity, in which the evidence is indeterminate with respect to consolidated content.

“Boundary sector” as used herein means the collection of interface regions surrounding all irreversible reservoirs within a cognitive substrate, carrying concentrated curvature and barrier energy, and constituting the sole channel through which curvature may flow between the active sector and the irreversible sector.

“Cognitive inflation” as used herein means a transient regime in the evolution of a cognitive substrate during which constitutive geometric structure is generated from an initially undifferentiated condition, characterized by an absorption rate below the external curvature flux rate, and governed by a differentiation sequence in which sector structure, curvature typing, routing channels, and timescale separation emerge progressively, wherein said inflation applies to initial bootstrapping, novel-domain integration, and sector merging as instances of a single structural genesis phenomenon.

“Cognitive substrate” as used herein means a structured geometric space, or a collection of interconnected geometric spaces, within which the cognitive operations of a persistent cognitive machine unfold, wherein said substrate is not a container for stored data but rather the medium whose geometric properties—including local curvature, transport structure, sector boundaries, and accumulated irreversible constraints—constitute the system's knowledge, reasoning capacity, and learned behavior, and wherein said substrate is reshaped by interaction rather than reset between uses.

“Cognitive trajectory” as used herein means a path through a cognitive substrate along which cognitive processing unfolds, wherein the effective result of processing depends on the trajectory itself—including its history and the geometric structure encountered along the way—rather than solely on the trajectory's starting and ending configurations.

“Connection” as used herein means a geometric structure on a cognitive substrate that defines how internal representations are transported along cognitive trajectories, satisfying path dependence such that the transport result depends on the trajectory taken and not merely on the endpoints, compositionality such that transport along a composed trajectory equals the composition of transport along the component segments, and stability under small perturbations of the trajectory.

“Consolidation” as used herein means the process by which curvature in the active sector of a cognitive substrate is exported through the boundary sector into the irreversible sector, wherein said process is energetically forced by the curvature conservation law rather than triggered by an externally imposed threshold, proceeds through progressive stages of curvature relaxation, boundary migration, and barrier accumulation, and results in an irreversible reservoir whose interior flatness, boundary energy, and admission control arise as derived consequences of exchange equilibrium rather than as design parameters.

“Constitutive exchange” as used herein means a structural interaction between a persistent cognitive machine and an external interface that results in an irreversible constraint on future cognitive trajectories, defined by its structural effect—a monotone increase in accumulated irreversible constraint—rather than by any particular mechanism, and distinguished from revisable adaptation in that the constraint cannot be weakened or reversed by any admissible internal operation.

“Control policy” as used herein means a set of rules, constraints, or parameters governing one or more of: which portions of a cognitive substrate are accessible during a given processing cycle, the rate or extent of substrate modification, conditions under which irreversible commitment is admissible, and enforcement of exchange channel legality.

“Curvature” as used herein means a geometric quantity measuring local incompatibility within a cognitive substrate, arising when transport of internal representations along different trajectories from the same starting configuration yields different results, wherein non-vanishing curvature registers that the local cognitive structure cannot be reduced to a simple product of independent components, and wherein curvature serves as the local generator of learning in that it identifies where existing geometric structure is insufficient to accommodate new experience.

“Curvature conservation law” as used herein means the constraint governing curvature exchange among the sectors of a cognitive substrate, providing that the rate of change of total curvature energy summed across the active sector, boundary sector, and irreversible sector equals the curvature flux injected by external experience, such that in the absence of new experience, curvature is redistributed among sectors but neither created nor destroyed.

“Curvature misrouting” as used herein means the unifying characterization of hallucination in a persistent cognitive machine as curvature that is deposited into the wrong sector, flows through an illegitimate exchange channel, or is prevented from reaching its correct destination, comprising: (a) channel bypass, in which curvature crosses a sector boundary through an inadmissible path; (b) curvature laundering, in which evidential curvature is absorbed into semantic structure thereby masking incoherence; (c) premature export, in which curvature is committed to the irreversible sector before exchange equilibrium is reached; and (d) blocked export, in which curvature that should consolidate is trapped in the active sector due to obstructed exchange channels.

“Epistemic connection” as used herein means a connection on a cognitive substrate that is independent of the semantic metric and whose transport properties measure evidential coherence along cognitive trajectories, wherein the curvature of said connection measures local evidential strain, and wherein the holonomy of said connection around closed trajectories provides a path-level diagnostic of whether a reasoning process maintained justificatory grounding, thereby enabling distinction between content that is semantically proximate but evidentially opposed.

“Epistemic curvature” as used herein means the curvature of an epistemic connection, measuring local evidential strain at a point or region of a cognitive substrate, wherein high epistemic curvature indicates unresolved or conflicting evidence and low epistemic curvature indicates evidential maturity, and wherein the relaxation of epistemic curvature through the boundary sector into the irreversible sector constitutes the primary mechanism of consolidation.

“Epistemic horizon” as used herein means a condition of a persistent cognitive machine in which cognitive transport remains well-defined and active but constitutive exchange is extinguished for all admissible interactions, such that structural time ceases to advance despite continued cognitive activity, wherein said horizon constitutes a structurally correct termination point of learning under finite accessibility rather than a failure of reasoning capacity.

“Epistemic phase” as used herein means a scalar diagnostic computed from the holonomy of an epistemic connection around a closed cognitive trajectory, measuring path-level evidential coherence and classifying the trajectory into one of: (a) a coherent regime in which consolidation is admissible; (b) a drift regime in which consolidation is deferred pending independent corroboration along a non-homotopic path; or (c) an inversion regime in which consolidation is blocked.

“Exchange accessibility” as used herein means a measure of the effective availability of constitutive exchange at a given point in cognitive processing, constituting a structural gate rather than a probability, wherein said accessibility may change abruptly under small changes in substrate configuration and is interface-conditioned such that the same evidence may be exchange-accessible under one interface and exchange-extinguished under another.

“Exchange channel” as used herein means a pathway through which curvature flows between geometric sectors of a cognitive substrate, the principal channels being: (a) consolidation, flowing from the active sector through the boundary sector to the irreversible sector; (b) restructuring, transferring curvature between semantic and evidential forms within the active sector; (c) boundary accumulation, concentrating curvature at reservoir boundaries; and (d) reflux, flowing from the irreversible sector through the boundary sector back to the active sector at substantially greater energetic cost than consolidation, wherein said asymmetry constitutes a thermodynamic directionality of learning.

“Exchange extinction” as used herein means a regime in which exchange accessibility equals zero for all admissible interactions while cognitive transport remains active, such that the system continues to operate internally but is structurally prohibited from producing irreversible commitment, and wherein continued generation of output carrying the posture of commitment during exchange extinction constitutes hallucination.

“Four-fold way” as used herein means the classification result establishing that the four structural primitives—curvature, holonomy, homotopy, and irreversible residual structure—form a closed and minimal basis for persistent cognition under the structural invariants, wherein removing any one primitive induces a unique long-horizon failure mode not resolved by the remaining primitives, and wherein no fifth primitive survives the combined enforcement of all invariants.

“Generalized Geometrodynamics” and “GGD” as used herein mean a universality class of dynamical systems characterized by: (a) decomposition into an active sector, an irreversible sector, and a boundary sector; (b) a conservation law governing exchange among said sectors; (c) exchange channels constrained by coupling geometry; (d) thermodynamic asymmetry favoring flow from the active sector to the irreversible sector; (e) horizon formation at exchange saturation; and (f) a coupling structure that constrains exchange without itself carrying exchangeable curvature, wherein a persistent cognitive machine constitutes a member of said universality class.

“Hallucination” as used herein means the production of cognitive output that presupposes admissible constitutive exchange in a condition where exchange is extinguished, or equivalently, the continuation of cognitive transport under the false assumption that structural time is advancing, or equivalently under the curvature conservation law, a misrouting of curvature to the wrong sector or through an illegitimate channel, wherein said characterization is structural rather than semantic such that a factually correct output may constitute hallucination if produced with the posture of irreversible commitment when no commitment is admissible.

“Hallucination resistance architecture” as used herein means a layered monitoring system operating on a cognitive substrate, comprising: (a) a first layer detecting topological inadmissibility of cognitive trajectories with respect to sector boundaries; (b) a second layer monitoring epistemic phase along reasoning paths to detect evidential drift or inversion; (c) a third layer enforcing capacity constraints on consolidation targets to prevent premature or over-generalized commitment; and (d) a fourth layer monitoring exchange rates between sectors to detect stagnation or blockage, wherein consolidation is admitted only if all layers produce non-blocking assessments.

“Holonomy” as used herein means the accumulated effect of transporting internal representations around a closed cognitive trajectory, measuring global constraint that is not detectable by purely local examination, wherein two closed trajectories are holonomy-equivalent if they produce the same accumulated transport effect, and wherein the quotient of trajectory space by holonomy equivalence constitutes the minimal compression of path-dependent experience that preserves behaviorally relevant constraint under finite representational capacity.

“Homotopy class” as used herein means an equivalence class of cognitive trajectories under admissible deformation, governing which reasoning loops are globally admissible, suppressible, or stabilizing, and distinguishing eliminable loops from non-eliminable ones, stabilizing cycles from oscillatory or divergent ones, and admissible revisitation from prohibited recurrence, wherein said distinctions are global properties that cannot be recovered from endpoint configurations, local cost, or holonomy alone.

“Interface” as used herein means a structured boundary through which a persistent cognitive machine interacts with external inputs, other cognitive machines, or other sectors of its own cognitive substrate, wherein said interface imposes a projection that is generally non-invertible and context-dependent, and wherein the non-commutativity of projections across different interfaces forces the sectorization of the cognitive substrate.

“Irreversible commitment” as used herein means an update to the accumulated constraints of a persistent cognitive machine that monotonically restricts future admissibility and cannot be weakened or reversed by any admissible internal operation, constituting the sole mechanism by which structural time advances, and distinguished from revisable adaptation which modifies the cognitive substrate without imposing monotone constraints.

“Irreversible reservoir” as used herein means a region of a cognitive substrate whose interior has reached exchange equilibrium such that evidential curvature has relaxed and been exported to the boundary, whose boundary carries accumulated barrier energy arising from said export, and whose contents are protected by admission control governing what new curvature may enter, wherein said conditions arise as derived consequences of the curvature conservation law rather than as externally imposed design parameters, and wherein the reservoir is non-navigable in that no admissible cognitive trajectory may modify its interior without first overcoming the barrier energy.

“Irreversible sector” as used herein means the collection of all irreversible reservoirs within a cognitive substrate, wherein said sector is non-navigable, emerges through consolidation dynamics rather than existing at initialization, and whose component reservoirs are mutually isolated such that curvature cannot flow directly between them without passing through the boundary sector and the active sector.

“Learning bifurcation” as used herein means the structural necessity that in any persistent cognitive system under finite capacity, revisable adaptation and irreversible commitment must be implemented as distinct processes, because no single update mechanism can simultaneously permit reversibility of some effects and enforce irreversibility of others, resulting in a bifurcation into a revisable process operating on the navigable portion of the cognitive substrate and a monotone process operating on the irreversible sector.

“Learning readiness” as used herein means a property of a boundary region of an irreversible reservoir measuring the ease with which existing consolidated knowledge extends into adjacent territory, wherein high readiness indicates compatible geometric structure and consistent evidence requiring low restructuring energy, and low readiness indicates evidentially incompatible or geometrically distant territory requiring substantial restructuring.

“Logarithmic scaling” as used herein means the property that effective internal complexity of a cognitive substrate grows as at most the logarithm of accumulated experience, constituting the characteristic asymptotic behavior of geometric compression under the structural invariants, and applying independently to each geometric measure of substrate complexity across all three sectors.

“Manifold” as used herein means a mathematical space equipped with sufficient structure to support paths, transport along paths, and curvature measuring local incompatibility, serving as the geometric realization of a cognitive substrate or a sector thereof.

“Mismatch functional” as used herein means a non-negative quantity measuring the disagreement between the geometric structures induced on a shared boundary by two adjacent sectors, vanishing if and only if the sectors' structures are mutually compatible, and providing the signal that drives boundary-mediated reconciliation and curvature generation.

“Navigable” as used herein means a property of a region of a cognitive substrate indicating that admissible cognitive trajectories may traverse, access, and potentially modify said region, as distinguished from non-navigable regions whose contents are accessible only as constraints on admissibility and cannot participate in trajectory generation or revisable modification.

“Non-navigable” as used herein means a property of a region of a cognitive substrate indicating that no admissible cognitive trajectory may traverse or modify the contents of said region, such that said contents function solely as irreversible constraints on future admissibility, wherein non-navigability is required for durability of irreversible commitments because any region that participates in cognitive transport is subject to revisable modification.

“Operational projection” as used herein means a generally non-invertible, context-dependent mapping from a cognitive substrate to an operationally accessible output, wherein said projections are non-commuting across contexts such that the order of context application affects the result and no single global projection suffices, and wherein said non-commutativity forces sectorization of the cognitive substrate into regions of local coherence separated by boundaries where incompatibility is reconciled.

“Parallel transport” as used herein means a path-dependent operation that carries internal representations along a cognitive trajectory, satisfying compositionality such that transport along a composed trajectory equals the composition of transport along the component segments, wherein said operation depends on the full trajectory and not merely on endpoints, and wherein the connection on the cognitive substrate is the local characterization of said transport.

Persistent cognitive machine” and “PCM” as used herein mean a computational system comprising one or more computing devices, together with one or more cognitive substrates, wherein said system satisfies: (a) persistence, in that the geometric structure of said substrates is not reset between interactions, sessions, or deployments, and past interaction leaves lasting geometric traces conditioning future behavior; (b) geometric compression, in that repeated or compatible experiences collapse into shared geometric structure such that growth in effective complexity is sublinear with accumulated experience; and (c) self-organization, in that structural alignment occurs through local adaptation driven by use without requiring global retraining; and wherein cognition unfolds as traversal within said substrates, learning corresponds to deformation of substrate geometry, and the system instantiates the four structural primitives of curvature, holonomy, homotopy, and irreversible residual structure.

“Persistent recursive quotienting” as used herein means the dynamical principle by which a cognitive substrate is continuously refined under experience through a monotone sequence of progressively simplified geometric structures, wherein curvature generates local distinctions initiating simplification pressure, holonomy induces simplification by identifying trajectories with equivalent transport effects, homotopy induces simplification by identifying trajectories connected by admissible deformations, and irreversible residual export induces simplification by removing exhausted structure from the navigable substrate entirely, and wherein said quotienting is recursive because new distinctions arise only after prior simplifications reveal previously masked structure.

“Processing cycle” as used herein means a defined interval or iteration during which a persistent cognitive machine accesses a portion of its cognitive substrate determined by current accessibility and control policies, performs computational operations including traversal, geometric deformation, and exchange evaluation, and optionally updates said substrate through either revisable adaptation or irreversible commitment.

“Projection operator” as used herein means an operator that maps external input into the geometric structure of a cognitive substrate, classifying outcomes into categories including: compatible absorption into existing structure, novel extension requiring substrate growth, contradiction requiring evidential reassessment, and ambiguity requiring provisional treatment, wherein every projection perturbs the geometric structure of the substrate and every geometric perturbation changes the effect of subsequent projections.

“Reflux” as used herein means an exchange channel through which curvature flows from the irreversible sector through the boundary sector back into the active sector, driven by accumulation of contradictory evidence at a reservoir boundary that is incompatible with the reservoir's consolidated content, requiring energy substantially exceeding the barrier energy to overcome the boundary, and constituting the mechanism by which previously consolidated knowledge is revised.

“Regime” as used herein means a macroscopically distinguishable phase of a cognitive substrate's constitutive dynamics, including: (a) a pre-constitutive regime in which sector structure has not yet differentiated; (b) a transitional regime in which constitutive structure is forming; (c) a steady-state regime in which all constitutive structures are functional and exchange is in balance; (d) a stagnation regime in which local sectors are healthy but cross-domain integration is failing due to rising epistemic horizons; and (e) a crisis regime in which constitutive structure is being destroyed by overwhelming contradictory evidence.

Residual structure” as used herein means the irreversible sector of a cognitive substrate considered as a structural primitive, into which exhausted or resolved cognitive effects are projected via a non-invertible operation, wherein said effects persist solely as constraints on future admissibility rather than as navigable structure, and wherein said projection establishes a directional arrow of cognitive time without appeal to external clocks or decay heuristics.

“Sector” as used herein means a geometrically coherent region of a cognitive substrate, wherein the three-sector decomposition of said substrate into an active sector, an irreversible sector, and a boundary sector emerges as a consequence of consolidation dynamics under the curvature conservation law rather than as an imposed architectural partition.

“Semantic metric” as used herein means a distance structure on a cognitive substrate wherein proximity corresponds to semantic relatedness, curvature encodes local complexity of semantic relationships, and parallel transport represents context transfer, said metric being one component of the geometric structure of the substrate and being independent of the epistemic connection.

“Structural time” as used herein means a measure of cognitive progression defined by accumulated irreversible commitments rather than by clock time, token count, iteration count, or computational effort, advancing if and only if constitutive exchange produces an irreversible constraint that reduces future admissibility, and remaining frozen during exchange-extinguished regimes regardless of the level of ongoing cognitive activity.

“Structural invariant” as used herein means any of five properties that any realization of general intelligence under finite energetic, representational, and temporal constraints must satisfy: (a) path dependence, in that future behavior depends on the trajectories by which the current configuration was reached; (b) interface-limited accessibility, in that only a restricted projection of internal structure is operationally accessible at any moment; (c) non-invertible residual export, in that some consequences of experience must be irreversibly exported from the operational space; (d) variational stabilization, in that experience deforms trajectory space so that equivalence classes of successful trajectories become locally stable; and (e) capacity scaling, in that effective internal complexity grows sublinearly with accumulated experience.

“Thermodynamic asymmetry” as used herein means the structural property of curvature exchange dynamics wherein consolidation from the active sector to the irreversible sector is energetically favored while reflux from the irreversible sector to the active sector requires substantially greater energy to overcome barrier energy, producing a directional bias in learning that constitutes the cognitive analogue of the second law of thermodynamics.

“Three-sector decomposition” as used herein means the partition of a cognitive substrate into an active sector, an irreversible sector, and a boundary sector, arising as a derived feature of consolidation dynamics under the curvature conservation law, and constituting an instance of the sector decomposition that is a universal feature of systems in the Generalized Geometrodynamics universality class.

“Variational stabilization” as used herein means the process by which experience deforms the geometric structure of a cognitive substrate such that equivalence classes of successful cognitive trajectories become locally stable under perturbation, operating on equivalence classes of trajectories rather than on individual trajectories, and constituting the mechanism by which learning reshapes the geometry of the substrate.

### Conceptual Architecture

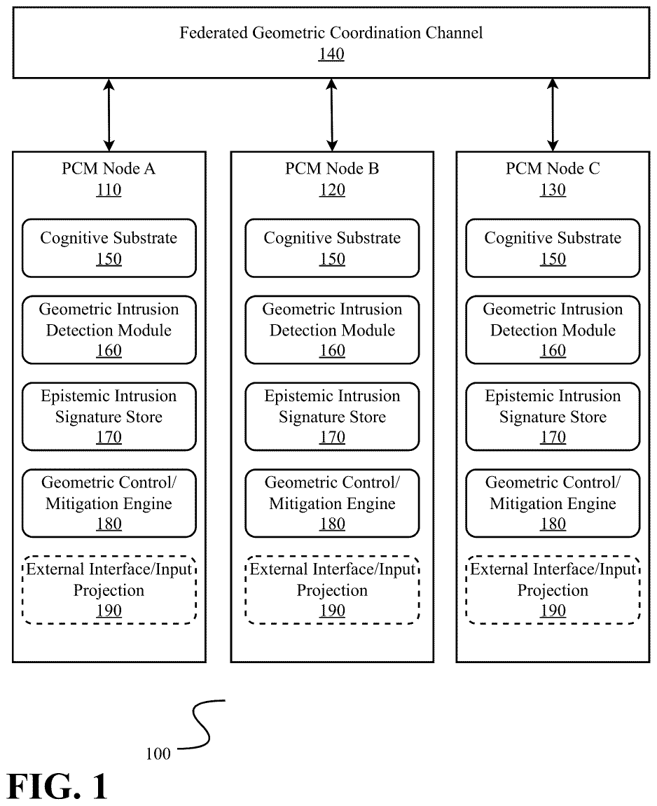

FIG. 1 is a block diagram illustrating an exemplary system architecture for a federated geometric intrusion detection system, according to an embodiment. The system 100 is configured for detecting, recording, and responding to epistemically illegitimate structural influences on one or more persistent cognitive machines. As used herein, an intrusion is not defined by anomalous data inputs, unexpected outputs, statistical deviation from a behavioral baseline, or known attack signatures. Rather, an intrusion comprises any external or adversarial process that attempts to induce epistemic phase drift, corrupt holonomy-based experiential memory, distort curvature or admissibility structure, force capacity exhaustion or over-compression, or stress or manipulate irreversible reservoir boundaries in a manner that is inconsistent with legitimate learning or reasoning dynamics. The system 100 is designed to detect such structural influences at the level of cognitive geometry rather than at the level of data or behavior, and to respond through architectural control of cognition rather than through heuristic remediation, rollback, or retraining.

According to an embodiment, system 100 comprises a federated geometric coordination channel 140 which is configured as the communication fabric through which a plurality of PCM nodes exchange security-relevant information. In the embodiment, the federated geometric coordination channel 140 interconnects a plurality of PCM nodes, which exemplary nodes shown as PCM Node A 110, PCM Node B 120, and PCM Node C 130, although the architecture of system 100 is not limited to any particular number of nodes or to any particular federation topology. The system 100 may be realized in peer-to-peer, hierarchical, hub-and-spoke, partially connected, or intermittently connected topologies, and federation need not be global or uniform across all nodes. An architectural property of the federated geometric coordination channel 140 is that only aggregated geometric invariants are exchanged among the participating nodes. No raw inputs or outputs, no reasoning trajectories, no manifold coordinates or embeddings, and no internal model parameters are transmitted through the channel 140. This separation of federated detection from cognitive content exposure is essential to both the security and the privacy properties of the system 100, and distinguishes the present architecture from federated learning approaches that require the sharing of gradients, parameters, or activations.

Each of the PCM nodes 110, 120, 130 comprises a plurality of cooperating architectural components that together implement geometric intrusion detection and mitigation as intrinsic functions of the persistent cognitive machine rather than as external security overlays. In the exemplary embodiment of system 100, each node comprises a cognitive substrate 150, a geometric intrusion detection module 160, an epistemic intrusion signature store 170, a geometric control and mitigation engine 180, and an external interface and input projection component 190. These components are illustrated as a vertically ordered processing hierarchy within each node for clarity of exposition; this ordering reflects a logical flow of geometric signals and control actions and is not intended to imply any particular physical arrangement, temporal sequencing, or implementation constraint.

The cognitive substrate 150 of each node constitutes the medium within which cognition unfolds and within which intrusion detection primitives operate. The cognitive substrate 150 is not a container for stored data but rather a structured geometric space, or a collection of interconnected geometric spaces, whose geometric properties—including local curvature, transport structure, sector boundaries, and accumulated irreversible constraints—constitute the system's knowledge, reasoning capacity, and learned behavior. The cognitive substrate 150 comprises an active sector in which reasoning and revisable adaptation occur, an irreversible sector comprising consolidated knowledge reservoirs that are non-navigable and protected by accumulated barrier energy, and a boundary sector comprising the interface regions surrounding the irreversible reservoirs through which all curvature exchange between the active sector and the irreversible sector is mediated. The cognitive substrate 150 further carries an epistemic connection whose curvature measures local evidential strain and whose holonomy around closed cognitive trajectories provides a path-level diagnostic of evidential coherence. The geometric structure of the cognitive substrate 150 is governed by a curvature conservation law providing that total curvature energy across all sectors changes only in response to externally introduced experience, such that curvature is redistributed among sectors but neither created nor destroyed in the absence of new experience. It is this persistent geometric structure that constitutes the protected asset of the system 100, and it is against this structure that all intrusion detection and mitigation mechanisms are directed.

Geometric intrusion detection module 160 is operatively coupled to the cognitive substrate 150 and is configured to continuously or opportunistically monitor a plurality of geometric indicators derived from the cognitive substrate 150 to detect the presence of epistemically illegitimate structural influence. According to an embodiment, geometric intrusion detection module 160 operates on intrinsic geometric properties of the cognitive substrate 150 rather than on the semantic content of inputs or outputs, such that detection is independent of the data modality, task domain, neural network architecture, or inference engine of the underlying system. The module 160 evaluates indicators including, without limitation, epistemic phase accumulation along cognitive trajectories and closed reasoning loops, holonomy-based experiential memory consistency, curvature distribution and structural imbalance between evidential and semantic geometric components, representational and consolidation capacity utilization, and reservoir boundary dynamics including barrier energy levels and boundary defect patterns. In some implementations, intrusion detection may not be based on any single indicator in isolation; rather, module 160 may evaluate correlations among multiple geometric signals, with confidence in an intrusion determination increasing with the persistence of anomalous signals and the degree of cross-signal agreement. Detection accordingly occurs during reasoning, at the path level and regime level, rather than at the level of individual inputs or outputs, enabling system 100 to detect attacks that produce locally correct-appearing results over extended periods.

Epistemic intrusion signature store 170 is operatively coupled to geometric intrusion detection module 160 and is configured to receive (or otherwise obtain), store, and maintain epistemic intrusion signatures generated in response to detected geometric violations. An epistemic intrusion signature, as used herein, is not a forensic log, a behavioral record, or a blacklist entry. Rather, an epistemic intrusion signature encodes the structural manner in which the cognitive geometry was stressed, including, for example, the magnitude and persistence of epistemic phase drift, the nature of curvature imbalance between contradiction-associated and novelty-associated components, repeated capacity saturation patterns, and the frequency and localization of reservoir boundary defects, without encoding any semantic content, attack payload, or reconstructible detail of the intrusion. Epistemic intrusion signatures are compact, non-invertible, and content-agnostic, rendering them safe to store locally and to transmit through federated geometric coordination channel 140 without exposing the cognitive content or manifold structure of the originating node. Signatures are generated only when geometric violations persist beyond transient noise thresholds, with multiple geometric signals optionally aggregated into a single signature, so as to avoid false positives arising from legitimate novelty or paradigm-shifting experience. Epistemic intrusion signatures are stored in signature store 170 using the same irreversible projection mechanisms that govern long-term consolidation as described herein, such that stored signatures are projected into non-navigable storage, influence future admissibility decisions asymmetrically, and cannot be traversed, replayed, or reconstructed into active cognition. The effect of a stored signature is to suppress recurrence of structurally similar geometric violations in future processing, with suppression occurring prior to execution of reasoning rather than after failure. Signature influence may decay if corroborating evidence disappears over time, and may be elevated from a local constraint to a shared federated constraint upon confirmation across multiple nodes.

Geometric control and mitigation engine 180 is operatively coupled to the geometric intrusion detection module 160 and to the cognitive substrate 150, and is configured to implement intrusion response through architectural control of cognition rather than through remediation, rollback, or patching of the affected substrate. Upon detection of an epistemically illegitimate structural influence, geometric control and mitigation engine 180 may execute one or more response actions including, without limitation: geometric quarantine, in which regions of the cognitive substrate exhibiting intrusion signatures are isolated from traversal such that reasoning may be rerouted around affected geometry and consolidation within quarantined regions is suspended; dynamic tightening of epistemic admission criteria, including increased thresholds for admissible projection, stricter phase coherence requirements, and higher evidentiary burdens for consolidation; capacity hardening measures, including lowering of allowable capacity density and deferral of abstraction until coherence improves; reinforcement of irreversible reservoir boundaries, including increased resistance to revision and stronger corroboration requirements for boundary-crossing updates; and intrusion-aware output gating, wherein outputs derived from quarantined or otherwise affected regions may be suppressed or qualified, and wherein the system may signal epistemic uncertainty to downstream consumers. All response actions executed by engine 180 are forward-looking and structural, directed at preventing further epistemically illegitimate influence and limiting propagation of structural damage, rather than at correcting the historical record of the cognitive substrate. Response actions are designed to be localized, non-destructive to unaffected knowledge regions, and reversible upon stabilization of conditions, so as to preserve the capacity for legitimate learning while the system is under or recovering from adversarial influence.

External interface and input projection component 190 constitutes the boundary through which each PCM node interacts with external inputs, other cognitive machines, or other sectors of its own cognitive substrate. The external interface 190 is illustrated with a dashed boundary in FIG. 1 to indicate that it represents the environmental boundary of the node rather than an internal architectural component. The external interface 190 imposes a projection that is generally non-invertible and context-dependent, mapping external input into the geometric structure of cognitive substrate 150. It is through this projection that adversarial inputs may first interact with the cognitive geometry of the node, and admission control enforced by geometric control and mitigation engine 180 may operate at or in connection with external interface 190 to restrict or condition the projection of inputs whose geometric character is inconsistent with current admissibility constraints.

In operation, PCM nodes 110, 120, 130 each independently monitor the geometric structure of their respective cognitive substrates 150 and communicate aggregated geometric invariants through the federated geometric coordination channel 140. Federated intrusion detection operates by comparing shared geometric indicators against expected envelopes or peer baselines, without assuming any single node to be authoritative. Disagreement among nodes in their geometric indicators is itself a detection signal, enabling identification of localized compromise affecting only a subset of nodes, coordinated attacks producing correlated geometric stress across multiple nodes, and gradual epistemic drift that remains locally plausible at any single node but is revealed as anomalous through cross-node comparison. Certain classes of attack, including cross-node epistemic desynchronization, in which an adversary targets only a subset of nodes with the goal of causing divergence in geometric indicators across the federation, cannot be reliably detected from the perspective of any single node and require federated comparison for identification. The federated geometric coordination channel 140 accordingly provides detection capabilities that are not available to standalone PCM deployments, while maintaining the architectural guarantee that no cognitive content, reasoning trajectory, or manifold structure is exposed through the federation.

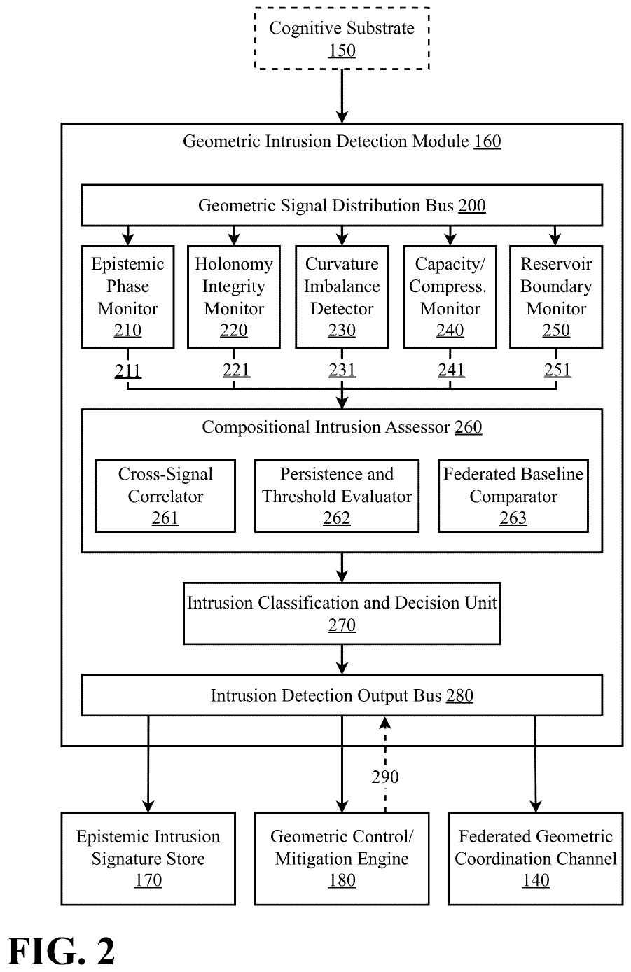

FIG. 2 is a block diagram illustrating an exemplary embodiment of geometric intrusion detection module 160. Module 160 constitutes the primary intrusion sensing apparatus within each PCM node of the federated geometric intrusion detection system 100. The geometric intrusion detection module 160 is an intrinsic architectural component of the persistent cognitive machine rather than an external security overlay, and operates entirely on geometric properties derived from cognitive substrate 150 without reference to the semantic content of inputs, outputs, or intermediate representations. In various embodiments, module 160 comprises, in a top-to-bottom processing hierarchy as illustrated: a geometric signal distribution bus 200; five parallel detection modules, namely an epistemic phase monitor 210, a holonomy integrity monitor 220, a curvature imbalance detector 230, a capacity and compression stress monitor 240, and a reservoir boundary dynamics monitor 250; a compositional intrusion assessor 260; an intrusion classification and decision unit 270; and an intrusion detection output bus 280. An admission control feedback path 290 returns control signals from the geometric control and mitigation engine 180 to the output bus 280, enabling dynamic adjustment of detection sensitivity in response to active mitigation. The hierarchical arrangement depicted in FIG. 2 is illustrative of logical signal flow and is not intended to impose any particular physical implementation, temporal ordering, or hardware partitioning.

The cognitive substrate 150 is shown at the top of the diagram with a dashed boundary to indicate that it is the source of geometric signals consumed by the module 160 rather than a component of the module itself. The cognitive substrate 150 continuously generates observable geometric quantities arising from the normal operation of the persistent cognitive machine, including the epistemic curvature of the epistemic connection across the active sector, the holonomy of the epistemic connection along completed or partially completed cognitive trajectories and closed reasoning loops, the distribution of curvature energy across the active, boundary, and irreversible sectors of the substrate, representational and consolidation capacity utilization relative to the structural limits of the substrate, and the pattern and frequency of boundary events at the boundaries of irreversible reservoirs. These geometric quantities are collected and made available to the five detection modules through geometric signal distribution bus 200. The geometric signal distribution bus 200 is configured to receive a continuous or opportunistic stream of geometric observables from cognitive substrate 150 and to distribute corresponding signals in parallel to each of the five detection modules. No semantic content, input data, output data, or reasoning trajectory content passes through bus 200; all signals distributed by bus 200 are purely geometric in character and are independent of the task domain, data modality, or inference architecture of the underlying system.

An epistemic phase monitor 210 receives epistemic phase measurements from geometric signal distribution bus 200 and is configured to detect anomalous patterns of epistemic phase accumulation along cognitive trajectories, with particular attention to closed or revisiting reasoning loops. The epistemic phase, as used herein, is a scalar diagnostic computed from the holonomy of the epistemic connection around a closed cognitive trajectory, and provides a path-level measure of evidential coherence. Under legitimate learning and reasoning dynamics, epistemic phase accumulates in a manner that is correlated with the introduction of genuine novelty, resolves as evidence matures through the boundary sector into the irreversible sector, and remains bounded within the coherent regime across repeated traversals of stable knowledge regions. Adversarial epistemic phase drift attacks, by contrast, aim to induce gradual phase accumulation along cognitive loops without triggering immediate contradiction, causing the system to lose evidential grounding over time while remaining locally coherent at any individual reasoning step. Epistemic phase monitor 210 detects such patterns by evaluating the rate, direction, and persistence of phase accumulation; identifying deviations from the coherent regime toward the drift regime or the inversion regime; and flagging long-horizon phase erosion that would not be apparent from inspection of any individual reasoning step. Upon detection of an anomalous phase pattern, epistemic phase monitor 210 generates a phase drift signal 211 encoding the magnitude, persistence, and trajectory-level localization of the detected deviation, which signal is transmitted to compositional intrusion assessor 260 for integration with signals from the other detection modules.

A holonomy integrity monitor 220 receives holonomy descriptors from geometric signal distribution bus 200 and is configured to detect anomalous changes in the path-dependent experiential memory structure encoded in the holonomy of cognitive substrate 150. Holonomy, as used herein, measures the accumulated effect of transporting internal representations around closed cognitive trajectories and encodes global constraints on reasoning that are not detectable by purely local examination of the substrate. Under legitimate operation, the holonomy structure of the cognitive substrate evolves in a manner consistent with the accumulation of genuine experience, with closure patterns across repeated trajectories exhibiting consistency that reflects the durable geometric traces left by prior constitutive exchange. Holonomy poisoning attacks, which have no analogue in token-based or stateless AI systems, attempt to manipulate path-dependent experiential memory by constructing adversarial loops whose closure produces artificially consistent holonomy that masks underlying incoherence, or by creating sequences of interactions that systematically rewrite experiential context in a manner that is not detectable from the perspective of any single loop traversal. Holonomy integrity monitor 220 detects such patterns by evaluating consistency of holonomy closure across non-homotopic paths, identifying unexpected changes in holonomy equivalence class structure, and detecting spurious holonomy consistency that is not corroborated by corresponding changes in curvature or epistemic phase. Upon detection of an anomalous holonomy pattern, monitor 220 generates a holonomy anomaly signal 221 encoding the nature and localization of the detected inconsistency for transmission to compositional intrusion assessor 260.

A curvature imbalance detector 230 receives curvature field measurements from geometric signal distribution bus 200 and is configured to monitor the distribution and structural balance of epistemic curvature across the sectors of cognitive substrate 150. Under legitimate learning and reasoning dynamics, curvature in the cognitive substrate is balanced and distributed in a manner consistent with the curvature conservation law, with curvature arising where existing geometric structure is insufficient to accommodate new experience, flowing through the boundary sector into the irreversible sector as consolidation proceeds, and eventually stabilizing as knowledge regions mature. Legitimate curvature is correlated across multiple geometric signals and tends toward resolution over structural time. Adversarial curvature stress, by contrast, tends to produce persistent, directional, or asymmetric curvature components that do not resolve through normal consolidation dynamics, exhibit patterns associated with contradiction rather than novelty, or reflect attempts to route curvature through illegitimate exchange channels in a manner inconsistent with the curvature conservation law. Curvature imbalance detector 230 detects such patterns by decomposing curvature into components associated with evidential novelty versus evidential contradiction, evaluating the asymmetry, persistence, and directional character of each component, and identifying curvature misrouting patterns including channel bypass, curvature laundering, premature export, and blocked export. Upon detection of anomalous curvature structure, detector 230 generates a curvature imbalance signal 231 encoding the nature, magnitude, and sector-level localization of the detected imbalance for transmission to compositional intrusion assessor 260.

A capacity and compression stress monitor 240 receives capacity utilization metrics from geometric signal distribution bus 200 and is configured to detect anomalous patterns of representational and consolidation capacity utilization that are inconsistent with legitimate learning dynamics. The system architecture enforces intrinsic structural limits on the density of geometric representation and the rate of consolidation within any region of the cognitive substrate, with effective complexity growing at most logarithmically with accumulated experience under the structural invariants. Capacity flooding and epistemic denial-of-service attacks exploit these limits by intentionally forcing over-compression or capacity saturation within targeted regions of the cognitive substrate, with the goal of exhausting representational capacity, preventing legitimate consolidation, or forcing premature generalization that degrades the reliability of the affected knowledge regions. Capacity and compression stress monitor 240 detects such patterns by evaluating capacity utilization against expected structural limits, identifying saturation events that occur without corresponding epistemic gain as measured by curvature relaxation and boundary energy accumulation, detecting persistent capacity pressure that is inconsistent with the logarithmic scaling properties of the architecture, and flagging attempts to force abstraction before evidential coherence has been established. Monitor 240 is configured to distinguish capacity stress arising from genuine knowledge growth, which is accompanied by correlated curvature resolution and consolidation progress, from capacity stress arising from adversarial flooding, which tends to be isolated from these correlated signals. Upon detection of anomalous capacity patterns, monitor 240 generates a capacity stress signal 241 encoding the severity, localization, and temporal character of the detected stress for transmission to compositional intrusion assessor 260.

A reservoir boundary dynamics monitor 250 receives boundary event data from geometric signal distribution bus 200 and is configured to monitor the activity, barrier energy levels, and defect patterns at the boundaries of irreversible reservoirs within cognitive substrate 150. The boundaries of irreversible reservoirs constitute the sole channel through which curvature may flow between the active sector and the irreversible sector, and are protected by accumulated barrier energy arising from prior consolidation. Under legitimate operation, revision pressure at reservoir boundaries is rare, correlated with the accumulation of substantial contradictory evidence across multiple independent paths, and accompanied by the characteristic signals of genuine paradigm revision rather than adversarial probing. Reservoir boundary probing attacks, by contrast, involve the repeated and localized application of stress to reservoir boundaries with the aim of probing revision thresholds, weakening consolidation barriers, or eventually forcing illegitimate modification of consolidated knowledge without the evidential support that would ordinarily be required to overcome the barrier energy. Such attacks are characterized by their slow, strategic, and localized nature, and may appear as a sequence of individually plausible interactions that do not individually trigger detection but collectively constitute an adversarial campaign against the integrity of one or more irreversible reservoirs. Reservoir boundary dynamics monitor 250 detects such patterns by evaluating the frequency, localization, and evidential character of boundary events; monitoring barrier energy levels for anomalous decay patterns inconsistent with legitimate revision dynamics; and constructing temporal boundary defect profiles that reveal the slow, strategic signature of probing attacks that would be invisible to any detector operating on instantaneous or short-window observations. Upon detection of anomalous boundary dynamics, monitor 250 generates a boundary anomaly signal 251 encoding the temporal profile, localization, and severity of the detected boundary activity for transmission to compositional intrusion assessor 260.

A compositional intrusion assessor 260 receives phase drift signal 211, holonomy anomaly signal 221, curvature imbalance signal 231, capacity stress signal 241, and boundary anomaly signal 251 from the five detection modules and is configured to perform multi-signal integration to produce a composite intrusion assessment that is more reliable than any individual signal considered in isolation. Compositional intrusion assessor 260 comprises three cooperating functional units: a cross-signal correlator 261, a persistence and threshold evaluator 262, and a federated baseline comparator 263. Cross-signal correlator 261 evaluates the correlations and co-persistence of anomalous signals across the five detection channels, exploiting the architectural property that legitimate learning produces correlated changes across multiple geometric signals while adversarial influence tends to produce asymmetric, directional, or isolated stress concentrated in one or a small number of channels. An intrusion determination made on the basis of correlated anomalies across multiple detection channels carries substantially higher confidence than a determination based on a single channel, and cross-signal correlator 261 is accordingly configured to weight multi-channel agreement more heavily than single-channel exceedance in computing the composite assessment. Persistence and threshold evaluator 262 evaluates whether anomalous signals from one or more detection channels persist beyond transient noise thresholds before admitting an intrusion determination, such that transient geometric anomalies arising from genuine novelty, paradigm-shifting evidence, or normal operational variation do not produce false positives. Evaluator 262 is configured to distinguish the temporal signature of adversarial influence, which tends to be persistent, directional, and resistant to resolution through normal consolidation dynamics, from the temporal signature of legitimate epistemic stress, which tends to be transient and accompanied by correlated resolution signals as evidence matures. Federated baseline comparator 263 receives aggregated geometric invariants from peer nodes through federated geometric coordination channel 140 and compares the local geometric indicators of the present node against peer-node envelopes to detect divergence patterns consistent with localized compromise or cross-node epistemic desynchronization. Comparator 263 is configured to treat divergence among nodes as a detection signal in its own right, independently of whether any individual node's local indicators exceed local anomaly thresholds, thereby enabling detection of attack classes that are specifically designed to remain locally plausible while producing detectable divergence at the federation level.

Intrusion classification and decision unit 270 receives the composite intrusion assessment from compositional intrusion assessor 260 and is configured to classify detected violations by geometric attack type and to issue a corresponding intrusion determination. The unit 270 classifies detected violations into one or more of the following non-exclusive geometric attack classes: epistemic phase drift attack, in which gradual phase accumulation is induced along cognitive loops without triggering immediate contradiction; holonomy poisoning, in which adversarial loop construction is used to manipulate path-dependent experiential memory; capacity flooding or epistemic denial-of-service, in which representational or consolidation capacity is saturated to prevent legitimate learning or force premature abstraction; reservoir boundary probing, in which irreversible reservoir boundaries are repeatedly stressed to weaken consolidation barriers; and cross-node epistemic desynchronization, in which divergence in geometric indicators across the federation is induced by targeting a subset of nodes. In some implementations, unit 270 issues one of multiple possible determinations, for example: INTRUSION CONFIRMED, indicating that the composite assessment meets or exceeds the threshold for an intrusion determination and that responsive action by geometric control and mitigation engine 180 and epistemic intrusion signature generation by signature store 170 are warranted; SUSPICION ELEVATED, indicating that anomalous signals are present but have not yet met the threshold for a confirmed intrusion determination and that heightened monitoring and tightened admission criteria are appropriate; and NO VIOLATION, indicating that geometric indicators are within expected envelopes and no intrusion-responsive action is required. The classification and determination produced by unit 270 are transmitted to the intrusion detection output bus 280 together with a geometric stress profile encoding the nature, magnitude, localization, and attack-type classification of the detected violation.

Intrusion detection output bus 280 receives the intrusion determination, geometric stress profile, attack type classification, and associated confidence level from intrusion classification and decision unit 270 and distributes these outputs to various downstream consumers, for example: epistemic intrusion signature store 170, geometric control and mitigation engine 180, and federated geometric coordination channel 140. Epistemic intrusion signature store 170 receives the geometric stress profile and, upon receiving an INTRUSION CONFIRMED determination, generates and stores an epistemic intrusion signature encoding the structural manner in which the cognitive geometry was stressed, without retaining any semantic content or reconstructible detail of the intrusion. Geometric control and mitigation engine 180 receives the intrusion determination and attack type classification and, in response, executes one or more architectural mitigation actions as described herein, including, but not limited to, geometric quarantine of affected substrate regions, dynamic tightening of epistemic admission criteria, capacity hardening, reservoir boundary reinforcement, and intrusion-aware output gating. Federated geometric coordination channel 140 receives aggregated geometric invariants derived from the output of module 160 for transmission to peer nodes in the federation, enabling federated detection of cross-node attacks and permitting peer nodes to elevate their own detection sensitivity in response to confirmed intrusions at the present node. It is to be noted that the information transmitted through federated geometric coordination channel 140 consists solely of aggregated geometric invariants and does not include any intrusion payload, attack content, reasoning trajectory, or manifold coordinate, preserving the architectural guarantee that federation does not compromise the cognitive privacy or security of any participating node.

Admission control feedback path 290 returns a control signal from geometric control and mitigation engine 180 to intrusion detection output bus 280, implementing a closed-loop dynamic adjustment of detection sensitivity in response to active mitigation. When geometric control and mitigation engine 180 executes a mitigation action in response to a confirmed or elevated intrusion determination, it may transmit a corresponding control signal through feedback path 290 that causes module 160 to tighten its detection thresholds, increase the sensitivity of one or more of the five detection modules, or modify the weighting applied by compositional intrusion assessor 260 to particular detection channels. This feedback mechanism ensures that the detection posture of module 160 adapts dynamically to the current security context, becoming more sensitive during periods of active or suspected intrusion and relaxing toward baseline sensitivity as conditions stabilize and mitigation actions are withdrawn. Feedback path 290 is illustrated with a dashed line in to indicate that it carries a control signal rather than a primary geometric detection signal, and does not itself constitute a detection channel. The admission control feedback path 290 is not required in all embodiments; implementations in which detection sensitivity is statically configured rather than dynamically adjusted remain within the scope of the present disclosure.

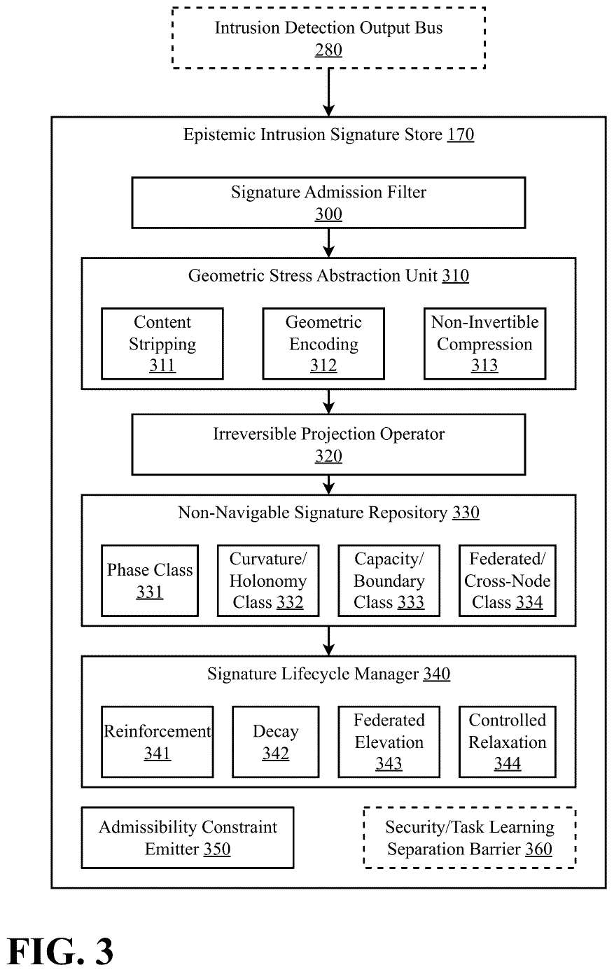

FIG. 3 is a block diagram illustrating an exemplary embodiment of the epistemic intrusion signature store 170. Epistemic intrusion signature store 170 can be configured as the mechanism by which a persistent cognitive machine operating acquires durable resistance to recurring adversarial influence without incorporating adversarial content, attack strategies, or corrupted cognition into its knowledge base. Epistemic intrusion signature store 170 is architecturally and functionally distinct from conventional security artifacts such as forensic logs, behavioral records, blacklists, replay buffers, and attack signature databases. Whereas such conventional artifacts record what occurred during an intrusion, preserving attack content, input sequences, or behavioral traces for subsequent analysis or matching, store 170 records only the structural manner in which the cognitive geometry of the persistent cognitive machine was stressed, without retaining any semantic content, attack payload, input data, or reconstructible detail of the intrusion. The stored artifacts, referred to herein as epistemic intrusion signatures, are compact, non-invertible, and content-agnostic, and function not as records but as irreversible admissibility constraints that suppress the recurrence of structurally similar geometric violations in future processing. The store 170 comprises, in the processing hierarchy illustrated in FIG. 3: a signature admission filter 300; a geometric stress abstraction unit 310; an irreversible projection operator 320; a non-navigable signature repository 330; a signature lifecycle manager 340; an admissibility constraint emitter 350; and a security and task learning separation barrier 360. The hierarchy depicted is illustrative of logical processing flow and does not prescribe any particular physical implementation or temporal ordering.

According to an embodiment, signature admission filter 300 receives intrusion determinations, geometric stress profiles, attack type classifications, and associated confidence levels from the intrusion detection output bus 280 and is configured to gate the signature generation process such that epistemic intrusion signatures are produced only under conditions that warrant durable structural constraint. The filter 300 may be configured to admit signature generation only upon receipt of an INTRUSION CONFIRMED determination accompanied by a geometric stress profile exhibiting persistence exceeding a noise threshold, such that transient geometric anomalies arising from legitimate novelty, paradigm-shifting evidence, or normal operational variation do not automatically produce signatures. A SUSPICION ELEVATED determination from intrusion classification and decision unit 270 does not, in the presently described embodiment, automatically trigger signature generation; rather, it may cause filter 300 to enter a heightened monitoring state in which subsequent determinations are evaluated against a reduced persistence threshold, such that a transition from SUSPICION ELEVATED to INTRUSION CONFIRMED in close temporal proximity produces signature generation more rapidly than would otherwise be the case. The conservative character of filter 300 is an intentional design property reflecting the irreversible nature of the projection operation performed by operator 320: because epistemic intrusion signatures, once projected, influence future admissibility in a manner that cannot be reversed by any admissible internal operation, filter 300 ensures that the store 170 does not accumulate false-positive signatures that would impose unnecessary constraints on legitimate future processing.

Geometric stress abstraction unit 310 receives a geometric stress profile admitted by filter 300 and is configured to transform that profile into a compact, content-agnostic, non-invertible representation suitable for storage as an epistemic intrusion signature. The unit 310 comprises various cooperating sub-functions: a content stripping stage 311, a geometric encoding stage 312, and a non-invertible compression stage 313. Content stripping stage 311 discards all semantic content, attack payload, input data, and any other reconstructible detail associated with the intrusion event, retaining only information describing the structural cause of the geometric stress—that is, the manner in which the cognitive geometry was deformed, stressed, or misrouted, independently of what content produced that stress. This operation ensures that no adversarial example, attack strategy, or domain-specific information is carried forward into the stored signature, preventing the class of contamination that afflicts adversarial training approaches in which the system is exposed to attack content during its security learning process. Geometric encoding stage 312 encodes the retained structural information into a geometric representation capturing, without limitation, the magnitude and directional character of any epistemic phase drift, the nature and sector-level localization of any curvature imbalance between evidential and semantic geometric components, the capacity stress profile including the degree and localization of any saturation events, and the temporal pattern of any reservoir boundary defects. Non-invertible compression stage 313 applies a non-invertible compression operation to the geometric encoding, producing a compact representation from which neither the original geometric stress profile nor any detail of the intrusion event can be reconstructed. The resulting compressed representation constitutes the pre-projection form of the epistemic intrusion signature and is passed to irreversible projection operator 320.

Irreversible projection operator 320 receives the compressed geometric representation from geometric stress abstraction unit 310 and projects it into non-navigable signature repository 330 via a non-invertible operation that is structurally consistent with the irreversible commitment mechanism governing long-term consolidation. The irreversible projection performed by operator 320 is a mechanism by which system 100 acquires durable structural memory of adversarial influence without incorporating that influence into the navigable portions of cognitive substrate 150. Upon projection, the resulting epistemic intrusion signature resides in non-navigable storage, influences future admissibility decisions asymmetrically, suppressing structurally similar violations without affecting unrelated processing, and cannot be traversed, queried, replayed, or reconstructed into active cognition by any admissible cognitive trajectory. The asymmetric character of the projected signature's influence is a direct consequence of the non-invertibility of the projection operation: because the projection cannot be reversed, the constraint imposed by the signature on future admissibility is permanent in the absence of controlled relaxation by signature lifecycle manager 340, and because the projection discards navigable geometric structure, the signature cannot participate in reasoning, be referenced by outputs, or contribute to task learning. Operator 320 is not required to implement a specific mathematical projection in all embodiments; any non-invertible operation that maps the compressed geometric representation into non-navigable repository 330 in a manner that produces the described admissibility effects falls within the scope of the present disclosure.

Non-navigable signature repository 330 is the persistent storage structure within which projected epistemic intrusion signatures reside. No admissible cognitive trajectory of the persistent cognitive machine may traverse or modify the contents of repository 330, and its contents function solely as irreversible constraints on future admissibility rather than as knowledge structures accessible to reasoning or output generation. Repository 330 organizes projected signatures into four non-exclusive classes corresponding to the primary geometric attack types described herein. Phase-class signatures 331 are derived from detected epistemic phase drift and phase inversion patterns and encode, without limitation, a drift magnitude class, a loop topology class characterizing the class of cognitive trajectories along which the drift was detected, and the persistence duration of the anomalous phase pattern; upon storage, phase-class signatures suppress re-entry into cognitive trajectories that are structurally similar to those along which the originating drift was detected. Curvature and holonomy-class signatures 332 are derived from detected curvature imbalance and holonomy poisoning patterns and encode a curvature imbalance class, the type of exchange channel misrouting detected, and a holonomy deviation class characterizing the anomalous closure pattern; upon storage, these signatures restrict structurally similar curvature exchange patterns and loop execution sequences. Capacity and boundary-class signatures 333 can be derived from detected capacity flooding and reservoir boundary probing patterns and encode a capacity saturation class, the boundary defect pattern associated with the detected probing campaign, and a temporal attack profile capturing the slow, strategic character of the originating attack; upon storage, these signatures harden capacity limits and raise boundary admission thresholds in the regions of the cognitive substrate affected by the originating attack. Federated and cross-node-class signatures 334 can be derived from confirmed cross-node epistemic desynchronization events detected through federated geometric coordination channel 140 and encode an inter-node divergence class, an associated federation confidence level reflecting the degree of cross-node corroboration, and a constraint scope indicator specifying whether the resulting constraint is to be applied locally or elevated to a shared federated constraint across participating nodes; upon storage, federated and cross-node-class signatures may cause the local node to adopt constraints that were confirmed by peer nodes, thereby distributing immunity across the federation without distributing attack content or cognitive exposure.

Signature lifecycle manager 340 can be configured to manage the influence strength, scope, and persistence of stored epistemic intrusion signatures over time, ensuring that repository 330 remains an adaptive security asset rather than a static or brittle constraint accumulator. Lifecycle manager 340 comprises multiple cooperating functional stages: a reinforcement stage 341, a decay stage 342, a federated elevation stage 343, and a controlled relaxation stage 344. The reinforcement stage 341 is configured to increase the suppressive influence of a stored signature upon receipt of corroborating geometric signals consistent with the attack class encoded in that signature, such that recurring adversarial influence of the same structural type produces progressively stronger constraint and the system's resistance to that class of attack improves with repeated exposure. The decay stage 342 is configured to gradually reduce the suppressive influence of a stored signature when corroborating signals consistent with that signature's attack class are absent for a sufficient period, reflecting the architectural principle that security constraints, like all irreversible commitments, should remain proportional to the evidence that supports them and should not accumulate indefinitely in the absence of ongoing adversarial pressure. The federated elevation stage 343 is configured to elevate the scope of a locally stored signature to a shared federated constraint upon receipt of confirmation from one or more peer nodes through federated geometric coordination channel 140 that those nodes have independently detected geometric violations consistent with the same attack class, thereby distributing durable structural immunity across the federation in response to corroborated adversarial campaigns. The controlled relaxation stage 344 is configured to permit the graduated lifting of admissibility constraints associated with stored signatures upon stabilization of the conditions that originally triggered signature generation, enabling the persistent cognitive machine to restore full operational capacity in affected regions of cognitive substrate 150 once the structural basis for the constraint has resolved. Controlled relaxation is distinguished from decay in that it is a deliberate, condition-gated process rather than a passive time-dependent process, and may require explicit confirmation that the geometric stress indicators associated with the originating attack class have returned to within normal envelopes before relaxation proceeds.

Admissibility constraint emitter 350 is configured to translate the influence of stored signatures in non-navigable repository 330, as managed by lifecycle manager 340, into active admissibility constraints that are delivered to three downstream consumers: geometric control and mitigation engine 180, the admissibility structure of cognitive substrate 150, and federated geometric coordination channel 140. Constraints delivered to geometric control and mitigation engine 180 inform active mitigation actions including geometric quarantine, dynamic admission tightening, and capacity hardening, enabling engine 180 to apply structural controls that are specifically calibrated to the class and severity of the stored signatures rather than to a uniform security posture. Constraints delivered to the admissibility structure of cognitive substrate 150 operate directly on the geometric conditions governing which cognitive trajectories are admissible in future processing cycles, such that suppression of recurrent attack patterns occurs prior to the execution of reasoning rather than after a violation has been detected, and without requiring the intervention of geometric intrusion detection module 160 for each instance of a recurrent structural pattern. Constraints delivered to federated geometric coordination channel 140 consist solely of abstracted constraint summaries that do not carry attack content, semantic information, or manifold coordinates, enabling peer nodes to incorporate the structural lessons of the present node's security history into their own admissibility structures without exposure to the cognitive content or intrusion details of the originating node. The admissibility constraint emitter 350 accordingly functions as the bridge between the irreversible storage of security learning and the active architectural enforcement of that learning, implementing the principle that in persistent cognitive systems, security is not something added after reasoning but something enforced by the geometry of cognition itself.

Security and task learning separation barrier 360 is depicted with a dashed boundary to indicate that it is an architectural partition rather than a processing stage. The barrier 360 enforces the structural separation between security learning, which operates on the admissibility constraints governing traversal and consolidation, and task learning, which operates on the semantic geometric structure of cognitive substrate 150 through the accumulation of experience and the consolidation of knowledge into irreversible reservoirs. This separation is a fundamental architectural property of store 170 and is not merely a policy or configuration parameter. Epistemic intrusion signatures stored in repository 330 do not participate in task reasoning, are not accessible to the output generation mechanisms of the persistent cognitive machine, cannot be queried or referenced by the active sector during normal processing, and do not contribute to the semantic metric or other geometric structures through which task knowledge is organized. The admissibility constraints emitted by emitter 350 influence the system's behavior by restricting which cognitive trajectories and consolidation operations are admissible, but do not alter the content or organization of knowledge within those trajectories. This separation ensures that the security learning process cannot contaminate task learning regardless of the nature, volume, or content of adversarial inputs processed by the system, and that the system's task knowledge remains unaffected by its history of security events. The barrier 360 further ensures that an adversary with knowledge of the system's stored intrusion signatures cannot infer anything about the system's task knowledge or cognitive substrate structure from those signatures, since the signatures encode only geometric stress patterns that are independent of semantic content. The security and task learning separation barrier 360 distinguishes the present architecture from adversarial training approaches, in which the security learning process operates on the same representational substrate as task learning and is therefore subject to the poisoning effects and brittleness that characterize those approaches.

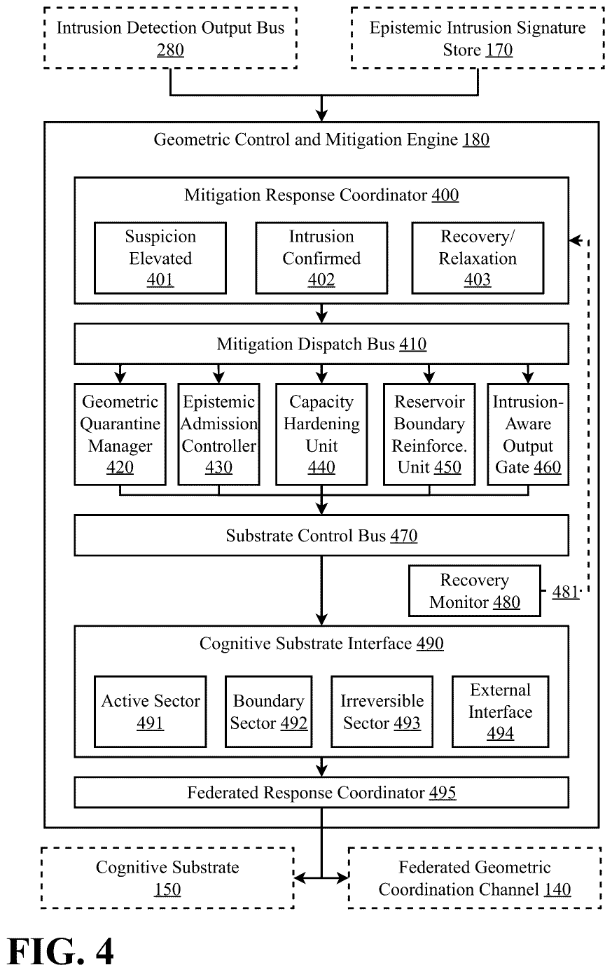

FIG. 4 is a block diagram illustrating an exemplary embodiment of a geometric control and mitigation engine. This components enables a mechanism by which a persistent cognitive machine responds to detected or suspected intrusion through structural control of cognition rather than through remediation, rollback, system suspension, or patching of the affected cognitive substrate. The engine 180 implements the principle that intrusion response in a persistent cognitive system must be architectural and forward-looking rather than corrective and historical: engine 180 does not attempt to undo or reverse the geometric effects of an intrusion, which may not be possible given the irreversible character of certain substrate modifications, but rather acts to prevent further epistemically illegitimate influence, limit the propagation of any structural damage to unaffected regions of cognitive substrate 150, preserve the integrity of legitimate knowledge structures, and adapt future admissibility criteria to reflect the current security context. All mitigation actions executed by engine 180 are localized, non-destructive to unaffected cognitive regions, and reversible upon stabilization of the conditions that triggered them. The engine 180 comprises, in the processing hierarchy illustrated in this embodiment: a mitigation response coordinator 400; a mitigation dispatch bus 410; five mitigation mechanisms, namely a geometric quarantine manager 420, an epistemic admission controller 430, a capacity hardening unit 440, a reservoir boundary reinforcement unit 450, and an intrusion-aware output gate 460; a substrate control bus 470; a cognitive substrate interface 490; a recovery monitor 480; and a federated response coordinator 495. The hierarchical arrangement depicted is illustrative of logical processing flow and does not prescribe any particular physical implementation, hardware partitioning, or temporal ordering.

The engine 180 receives inputs from various sources. The intrusion detection output bus 280 provides the intrusion determination, geometric stress profile, attack type classification, and associated confidence level produced by intrusion classification and decision unit 270 of geometric intrusion detection module 160. The epistemic intrusion signature store 170 provides active admissibility constraints derived from stored epistemic intrusion signatures, including the signature class, current influence strength, and scope of each active constraint as managed by signature lifecycle manager 340. These two input streams are received by mitigation response coordinator 400, which is the central orchestration component of engine 180 and is configured to determine which mitigation mechanisms are engaged, at what intensity, and for what duration, based on the current response level and attack type classification. The coordinator 400 operates across three graduated response levels. The first exemplary response level, Suspicion Elevated 401, may be engaged when geometric intrusion detection module 160 issues a SUSPICION ELEVATED determination, and corresponds to a posture of heightened monitoring and tightened admission thresholds without structural isolation of affected substrate regions; at this level, coordinator 400 activates epistemic admission controller 430 and issues instructions to recovery monitor 480 to increase the frequency of geometric indicator evaluation. A second response level, Intrusion Confirmed 402, may be engaged when geometric intrusion detection module 160 issues an INTRUSION CONFIRMED determination, and corresponds to full engagement of the mitigation repertoire including geometric quarantine, capacity hardening, reservoir boundary reinforcement, and intrusion-aware output gating in addition to tightened admission control; the specific combination and intensity of mechanisms activated at this level is calibrated to the attack type classification received from intrusion detection output bus 280, such that a detected capacity flooding attack engages capacity hardening unit 440 with heightened priority, a detected reservoir boundary probing attack engages reservoir boundary reinforcement unit 450 with heightened priority, and so forth. A third response level, Recovery and Relaxation 403, may be engaged upon signal from recovery monitor 480 that geometric indicators have returned to within-envelope conditions, and corresponds to the graduated lifting of active mitigation constraints, monitored reintegration of previously quarantined substrate regions, and retention of only those durable structural lessons that have been committed to epistemic intrusion signature store 170 for long-term admissibility conditioning.

The mitigation dispatch bus 410 receives response instructions from mitigation response coordinator 400 and routes them in parallel to each of the five mitigation mechanisms based on the active response level and the attack type classification associated with the current intrusion determination. Dispatch bus 410 can be configured to activate any combination of a plurality of mitigation mechanisms simultaneously and to modulate the intensity of each mechanism independently, such that engine 180 may apply a precisely calibrated response profile that addresses the specific geometric character of the detected attack without engaging mitigation actions that are irrelevant to that character and that would impose unnecessary constraints on legitimate processing. Dispatch bus 410 may also receive updated instructions from coordinator 400 during an active response, enabling engine 180 to adapt its mitigation posture dynamically as the geometric stress profile evolves or as additional detection signals are received from the geometric intrusion detection module 160.

In some implementations, geometric quarantine manager 420 is configured to isolate regions of cognitive substrate 150 exhibiting intrusion signatures from active traversal, thereby preventing the propagation of adversarial geometric influence from affected regions to healthy regions and suspending the accumulation of further structural damage in the affected area. Upon activation by dispatch bus 410, quarantine manager 420 applies traversal restrictions to the affected region of the cognitive substrate such that no admissible cognitive trajectory may enter or pass through the quarantined region during the period of active quarantine. Reasoning processes that would ordinarily traverse the quarantined region are rerouted around the affected geometry to the extent that admissible alternative paths exist within cognitive substrate 150, preserving the operational continuity of the persistent cognitive machine in unaffected domains. Consolidation of curvature into the irreversible sector is suspended within the quarantined region during active quarantine, preventing premature or structurally incoherent commitment of knowledge that may have been influenced by adversarial interaction. Quarantine is localized in scope, applying only to the specific region or regions of the cognitive substrate identified as exhibiting intrusion signatures, and does not require suspension of cognitive operation in unaffected regions. Quarantine is reversible upon signal from recovery monitor 480 that the geometric indicators associated with the affected region have returned to within-envelope conditions, at which point quarantine manager 420 initiates a monitored reintegration process under the coordination of recovery and relaxation response level 403 of coordinator 400. Quarantine is non-destructive to the legitimate knowledge structures within the quarantined region, which remain intact and available for reintegration upon recovery.

The epistemic admission controller 430 is configured to dynamically adjust the epistemic admission criteria applied at external interface and input projection component 190 in response to the active response level and attack type classification. Under normal operation, the admission criteria governing the projection of external inputs into the geometric structure of cognitive substrate 150 are calibrated to the baseline epistemic tolerance of the system; upon activation of controller 430 by dispatch bus 410, these criteria are tightened in one or more of the following (non-limiting) respects: the threshold for admissible projection is increased, such that inputs producing geometric perturbations below the elevated threshold are rejected or deferred; the phase coherence requirement for admitted projections is increased, such that inputs exhibiting epistemic phase characteristics inconsistent with the current coherent regime of the active sector are not admitted; the evidentiary burden required for consolidation of projected inputs is elevated, such that newly projected geometric content must satisfy more stringent coherence and corroboration requirements before it is permitted to flow through the boundary sector into the irreversible sector; and the tolerance for curvature imbalance between evidential and semantic components of newly projected inputs is reduced, such that inputs producing asymmetric or directional curvature patterns are subjected to additional evaluation before admission. The controller 430 may apply tightened admission criteria globally across external interface 190 or selectively to specific interface regions or input classes identified as consistent with the attack type classification, and may modulate the degree of tightening continuously as a function of the evolving geometric stress profile. Admission tightening is reversible and is relaxed by coordinator 400 upon transition to the Recovery and Relaxation response level 403.

The capacity hardening unit 440 is configured to temporarily harden the representational and consolidation capacity limits of cognitive substrate 150 against capacity flooding and epistemic denial-of-service attacks of the type described in connection with capacity and compression stress monitor 240 of geometric intrusion detection module 160. Upon activation by dispatch bus 410, hardening unit 440 applies one or more of the following capacity controls to the affected region or regions of the cognitive substrate: the allowable capacity density within the affected region is lowered below its normal operational level, reducing the maximum geometric complexity that may be accumulated per unit of structural area and thereby resisting attempts to force over-compression through volume-based flooding; the cognitive substrate is directed to favor finer-grained geometric representation over abstraction and compression within the affected region, preventing adversarial inputs from exploiting compression mechanisms to induce premature generalization; abstraction operations within the affected region are deferred until evidential coherence, as measured by curvature relaxation and epistemic phase stabilization, has recovered to within-threshold levels; and consolidation of curvature from the active sector into the irreversible sector within the affected region is blocked while active capacity stress persists, preventing the commitment of knowledge that may have been distorted by the flooding attack from becoming permanently embedded in the irreversible reservoirs of the cognitive substrate. The capacity hardening unit 440 is regional in scope, applying only to the portions of the cognitive substrate identified as exhibiting capacity stress, and its controls are reversible upon confirmation by recovery monitor 480 that capacity utilization has returned to within-envelope conditions.

The reservoir boundary reinforcement unit 450 is configured to reinforce the boundaries of irreversible reservoirs within cognitive substrate 150 that are identified as targets of reservoir boundary probing attacks of the type described in connection with reservoir boundary dynamics monitor 250 of geometric intrusion detection module 160. The irreversible reservoirs of the cognitive substrate encode durable consolidated knowledge and are protected under normal operation by the barrier energy accumulated during the consolidation process; a reservoir boundary probing attack aims to weaken this barrier energy through repeated localized stress, eventually reducing the revision threshold to a level at which illegitimate modification of the consolidated knowledge becomes possible. Upon activation by dispatch bus 410, reinforcement unit 450 applies one or more of the following (non-limiting) reinforcement actions to the challenged reservoir boundary: the resistance of the challenged boundary to revision is increased beyond its current barrier energy level, requiring adversarial inputs to overcome a higher energetic barrier than the one they have been probing; the corroboration requirement for boundary-crossing updates at the challenged boundary is strengthened, such that modifications to the consolidated content of the associated reservoir require stronger and more broadly distributed evidential support than would ordinarily be required; boundary defect patterns detected at the challenged boundary are recorded and forwarded to signature lifecycle manager 340 of epistemic intrusion signature store 170 for potential incorporation into a capacity and boundary-class signature 333; and the challenged region of the reservoir boundary is isolated from the reservoir interior, such that adversarial pressure on the challenged boundary region does not propagate to the broader consolidated knowledge structure of the reservoir. The reinforcement unit 450 can be configured to be boundary-local in scope, applying only to the specific reservoir boundary regions identified as targets of probing activity, and its reinforcement actions are reversible and may be relaxed under the coordination of recovery and relaxation response level 403 upon confirmation that boundary probing activity has ceased and geometric indicators have stabilized.

The intrusion-aware output gate 460 is configured to control the external expression of outputs derived from quarantined or otherwise adversarially influenced regions of cognitive substrate 150, ensuring that intrusion response prevents both internal geometric corruption and external misrepresentation of the system's epistemic status. The gate 460 operates downstream of all other geometric control actions executed by engine 180 and is therefore the final architectural checkpoint through which outputs pass before external expression. Upon activation by dispatch bus 410, gate 460 applies one or more of the following (non-limiting) output control actions: outputs that are derived wholly or substantially from quarantined regions of the cognitive substrate are suppressed, preventing the external expression of reasoning that may have been influenced by adversarial geometric manipulation; outputs derived from regions of the cognitive substrate that are proximate to but not wholly within quarantined areas are qualified with an epistemic uncertainty signal indicating that the associated reasoning may be subject to reduced evidential grounding, enabling downstream consumers of the system's outputs to apply appropriate caution; the confidence level associated with outputs is reduced even in cases where the local reasoning process within the generating region appears internally coherent, reflecting the architectural principle that epistemic coherence is a necessary but not sufficient condition for reliable output when the broader geometric context of the cognitive substrate has been compromised; and gate 460 ensures that the output control actions it applies are themselves not exposed to or influenced by the adversarial geometric content that triggered them, such that the gate cannot be circumvented by adversarial manipulation of the output generation process. The gate 460 is reversible and its output controls are lifted by coordinator 400 upon transition to Recovery and Relaxation response level 403 as the associated quarantine and admission controls are withdrawn.

The substrate control bus 470 aggregates the geometric control instructions produced by the five mitigation mechanisms and delivers them to cognitive substrate interface 490, which maps each instruction to its target sector within cognitive substrate 150. The cognitive substrate interface 490 comprises four target zone mappings corresponding to the three sectors of the cognitive substrate and the external interface component. The active sector target 491 receives traversal restriction instructions from geometric quarantine manager 420 and admission tightening instructions from epistemic admission controller 430, and is responsible for applying these instructions to the navigable geometric structure of the active sector such that quarantined regions are excluded from cognitive trajectory generation and newly admitted inputs satisfy the tightened admission criteria. The boundary sector target 492 receives boundary reinforcement instructions from reservoir boundary reinforcement unit 450 and consolidation gating instructions from capacity hardening unit 440 and geometric quarantine manager 420, and is responsible for applying these instructions to the exchange channels through which curvature flows between the active sector and the irreversible sector, ensuring that consolidation and revision satisfy the elevated requirements established by the active mitigation posture. The irreversible sector target 493 receives reservoir protection instructions from reservoir boundary reinforcement unit 450 and is responsible for applying barrier energy elevation and interior isolation to the specific reservoir regions identified as targets of probing activity, while preserving the integrity of all other irreversible reservoirs. The external interface target 494 receives projection gating and admission threshold instructions from the epistemic admission controller 430 and intrusion-aware output gate 460, and is responsible for applying these instructions at external interface and input projection component 190 such that inputs are evaluated against tightened criteria before projection and outputs are subject to gate 460 before external expression.

The recovery monitor 480 is configured to continuously evaluate the geometric indicators of cognitive substrate 150 during an active mitigation response to determine whether the conditions that triggered the response have abated sufficiently to warrant a transition toward Recovery and Relaxation response level 403. The monitor 480 receives geometric indicator data from substrate control bus 470 reflecting the current state of the sectors of the cognitive substrate under active mitigation, and evaluates these indicators against the within-envelope conditions corresponding to the attack type classification of the active intrusion determination. When monitor 480 determines that geometric indicators have returned to within-envelope conditions and have remained within those conditions for a sufficient period to exclude transient recovery artifacts, it transmits a recovery feedback signal 481 to mitigation response coordinator 400 through the recovery feedback path, which causes coordinator 400 to initiate a graduated transition toward Recovery and Relaxation response level 403. The transition is graduated rather than immediate, such that mitigation controls are lifted incrementally and the geometric indicators of the recovering region are monitored at each stage of relaxation to confirm that the recovery is proceeding without renewed adversarial influence. If geometric indicators deteriorate during the recovery transition, coordinator 400 may reverse the transition and re-engage the Intrusion Confirmed response level 402 without requiring a new INTRUSION CONFIRMED determination from the geometric intrusion detection module 160. The admission control feedback path 290 additionally returns a control signal from the engine 180 to intrusion detection output bus 280 and thence to geometric intrusion detection module 160, dynamically tightening the detection sensitivity of the module 160 during active mitigation to ensure that renewed or escalating adversarial activity is detected more rapidly than it would be under baseline detection sensitivity.

According to an embodiment, federated response coordinator 495 is configured to communicate the active mitigation status and response level of the present node to peer nodes in the federation through federated geometric coordination channel 140, enabling a coordinated federation-level response posture without sharing cognitive content, attack detail, or mitigation specifics that could expose the cognitive structure of the present node. When coordinator 400 engages the Intrusion Confirmed response level 402 or the Suspicion Elevated response level 401, federated response coordinator 495 transmits an abstracted status signal through federated geometric coordination channel 140 indicating the active response level, the geometric attack class of the triggering intrusion determination, and the federation confidence level associated with the intrusion determination, without transmitting the geometric stress profile, the intrusion payload, the specific substrate regions affected, or any other detail that could permit inference about the cognitive content or geometric structure of the present node. Peer nodes receiving this status signal through channel 140 may use it to elevate their own detection sensitivity through epistemic admission controller 430 of their respective engines 180, to trigger federated elevation of locally stored epistemic intrusion signatures of the corresponding attack class through the federated elevation stage 343 of their respective signature lifecycle managers 340, or to enter the Suspicion Elevated response level 401 of their respective mitigation response coordinators 400 in anticipation of corroborating local detections. Federated response coordinator 495 thereby enables system 100 to mount a coordinated defensive posture across all participating nodes in response to a confirmed intrusion at any single node, without requiring centralized inspection of any node's cognitive substrate or exposing any node's cognitive content through the federation.

### Detailed Description of Exemplary Aspects

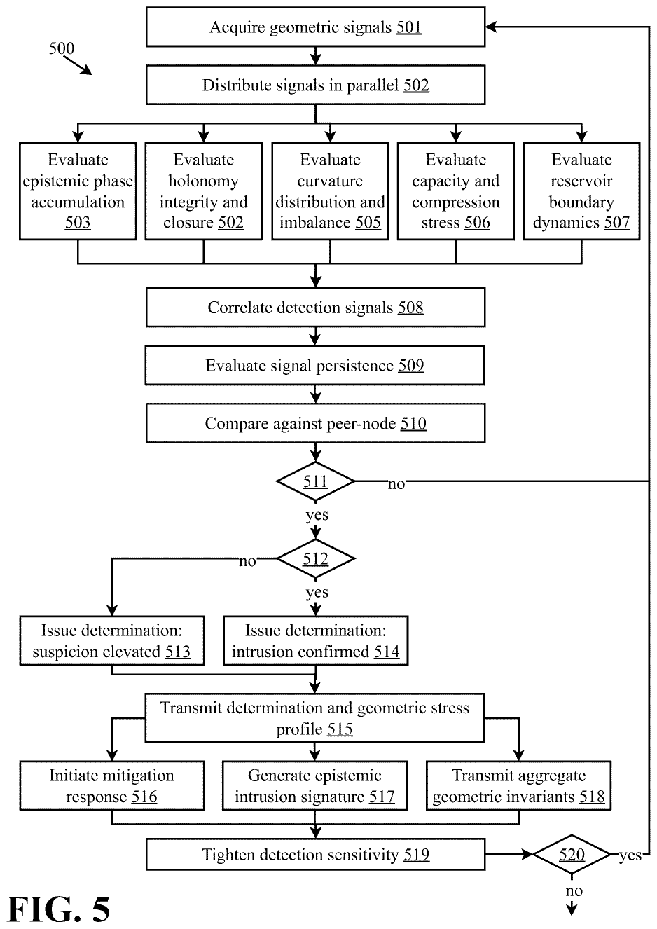

FIG. 5 is a flow diagram of an exemplary method 500 of detecting a geometric intrusion in a single PCM node, according to an embodiment. The method 500 may be implemented by geometric intrusion detection module 160 of the PCM node and operates as a continuous monitoring cycle that runs concurrently with the normal reasoning and learning operations of the persistent cognitive machine. The method 500 does not interrupt, suspend, or condition the execution of cognitive operations during its normal monitoring cycle; intrusion detection occurs as a parallel structural observation rather than as a gate on cognitive processing. The method 500 is content-agnostic throughout: at no step does the method evaluate the semantic content of inputs, outputs, or intermediate representations of the persistent cognitive machine, such that the method is applicable across all task domains, data modalities, and cognitive substrate configurations without modification.

According to the embodiment, the process begins at step 501 when the method obtains geometric signals from cognitive substrate 150 via geometric signal distribution bus 200. The geometric signals acquired at step 501 reflect the current structural state of the cognitive substrate 150 and include, without limitation, epistemic phase measurements along active and recently completed cognitive trajectories, holonomy descriptors encoding the path-dependent experiential memory structure of the substrate, curvature field measurements reflecting the distribution of evidential strain across the active, boundary, and irreversible sectors, capacity utilization metrics relative to the structural limits of the substrate, and boundary event data reflecting the frequency and character of interactions at the boundaries of irreversible reservoirs. These geometric signals are intrinsic products of the normal operation of the cognitive substrate 150 and are available continuously without requiring any modification to the cognitive processing pipeline. At step 502, the acquired geometric signals are distributed in parallel to five detection channels via the geometric signal distribution bus 200, each of which evaluates a distinct class of geometric indicator independently and concurrently with the others.

Steps 503 through 507 execute in parallel, each constituting the evaluation performed by one of the five detection modules of geometric intrusion detection module 160. At step 503, epistemic phase monitor 210 evaluates epistemic phase accumulation along cognitive trajectories and closed reasoning loops, producing a phase drift signal 211 encoding the magnitude, persistence, and trajectory-level localization of any detected phase anomaly. At step 504, holonomy integrity monitor 220 evaluates the consistency of holonomy closure across cognitive trajectories and the integrity of the path-dependent experiential memory structure of the cognitive substrate, producing a holonomy anomaly signal 221 encoding the nature and localization of any detected inconsistency in holonomy structure. At step 505, curvature imbalance detector 230 evaluates the distribution and structural balance of epistemic curvature across the sectors of the cognitive substrate, producing a curvature imbalance signal 231 encoding the nature, magnitude, and sector-level localization of any detected curvature asymmetry or misrouting pattern. At step 506, capacity and compression stress monitor 240 evaluates representational and consolidation capacity utilization against the structural limits of the substrate, producing a capacity stress signal 241 encoding the severity, localization, and temporal character of any detected capacity anomaly. At step 507, reservoir boundary dynamics monitor 250 evaluates the activity, barrier energy levels, and defect patterns at irreversible reservoir boundaries, producing a boundary anomaly signal 251 encoding the temporal profile, localization, and severity of any detected boundary stress. Each of the five detection steps 503 through 507 produces its output signal regardless of whether an anomaly is detected, such that a null or within-envelope signal is a positive output of each step rather than an absence of output, and the convergence at step 508 always receives a complete set of five signals.

Steps 508 through 510 constitute the compositional assessment performed by compositional intrusion assessor 260 of geometric intrusion detection module 160. At step 508, cross-signal correlator 261 evaluates correlations and co-persistence among the five detection signals produced at steps 503 through 507, computing a composite anomaly profile that reflects the degree to which the five signals exhibit patterns of mutual corroboration characteristic of genuine adversarial influence as distinguished from the uncorrelated single-channel anomalies characteristic of legitimate novelty or operational variation. At step 509, persistence and threshold evaluator 262 evaluates whether the anomalous components of the composite anomaly profile have persisted beyond transient noise thresholds over sufficient structural time to warrant advancement to the determination stage, distinguishing the sustained, directional anomaly pattern characteristic of adversarial influence from the transient, self-resolving anomaly pattern characteristic of legitimate epistemic stress. At step 510, federated baseline comparator 263 compares the composite anomaly profile of the present node against the aggregated geometric indicator envelopes received from peer nodes through the federated geometric coordination channel 140, evaluating whether the local indicators of the present node diverge from the peer-node envelopes in a manner consistent with localized compromise or cross-node epistemic desynchronization. The comparison performed at step 510 may itself constitute an independent detection signal: a local composite anomaly profile that remains within local thresholds but diverges significantly from peer-node envelopes may satisfy the composite anomaly threshold at decision 511 on the basis of divergence alone, without any individual detection channel having exceeded its local anomaly threshold.

At decision point 511, the method determines whether the composite anomaly profile produced by compositional intrusion assessor 260 at steps 508 through 510 exceeds the composite anomaly threshold. If the composite anomaly threshold is not exceeded, the method proceeds along the NO branch, returning directly to step 501 to begin the next monitoring cycle without issuing any determination and without initiating any mitigation or signature generation activity. This branch reflects the operational configuration that geometric intrusion detection module 160 operates continuously and opportunistically, evaluating geometric indicators at each monitoring cycle without imposing any processing overhead or behavioral modification on cognitive substrate 150 when no anomaly threshold is exceeded. If the composite anomaly threshold is exceeded, the method proceeds along the YES branch to decision 512.

At decision point 512, the method determines whether the composite anomaly that exceeded the threshold at decision 511 is corroborated by anomalous signals from multiple detection channels. Multi-channel corroboration, as evaluated at decision 512, requires that the composite anomaly profile reflect anomalous co-persistence across at least two of the five detection channels at levels exceeding the correlation thresholds of cross-signal correlator 261; a composite anomaly arising from a single detection channel that has individually exceeded its local threshold but is not corroborated by any other channel does not satisfy the multi-channel corroboration criterion at decision 512. If multi-channel corroboration is not confirmed, the method proceeds along the NO branch to step 513, at which intrusion classification and decision unit 270 issues a SUSPICION ELEVATED determination, indicating that anomalous geometric signals are present and that heightened monitoring and tightened admission criteria are warranted, but that the evidence does not yet satisfy the threshold for an INTRUSION CONFIRMED determination. The SUSPICION ELEVATED determination does not trigger irreversible signature generation at epistemic intrusion signature store 170 and does not activate structural isolation actions such as geometric quarantine; it causes mitigation response coordinator 400 to engage the Suspicion Elevated response level 401 of geometric control and mitigation engine 180. The determination issued at step 513 merges with the main flow at step 515. If multi-channel corroboration is confirmed, the method proceeds along the YES branch to step 514, at which intrusion classification and decision unit 270 issues an INTRUSION CONFIRMED determination and classifies the detected intrusion by geometric attack type, assigning one or more of the following classifications to the intrusion determination: epistemic phase drift attack, holonomy poisoning, capacity flooding or epistemic denial-of-service, reservoir boundary probing, or cross-node epistemic desynchronization, based on the pattern of anomalous signals across the five detection channels and the attack type indicators in the geometric stress profile.

At step 515, the intrusion determination issued at step 513 or step 514 is transmitted to intrusion detection output bus 280 together with the geometric stress profile encoding the nature, magnitude, localization, and attack type classification of the detected anomaly and the confidence level associated with the determination. The intrusion detection output bus 280 may distribute these outputs to a plurality of downstream consumers in parallel, for example: geometric control and mitigation engine 180, epistemic intrusion signature store 170, and federated geometric coordination channel 140. The method then proceeds to the three parallel steps 516 through 518, which execute concurrently.

At step 516, geometric control and mitigation engine 180 receives the intrusion determination and geometric stress profile from intrusion detection output bus 280 and initiates a mitigation response calibrated to the active response level and attack type classification, engaging one or more of geometric quarantine, epistemic admission tightening, capacity hardening, reservoir boundary reinforcement, and intrusion-aware output gating as described herein. At step 517, epistemic intrusion signature store 170 receives the intrusion determination and geometric stress profile and, if and only if the determination is INTRUSION CONFIRMED and the geometric stress profile exhibits persistence meeting the signature admission threshold of signature admission filter 300, generates an epistemic intrusion signature by executing the content stripping stage 311, geometric encoding stage 312, non-invertible compression stage 313, and irreversible projection operator 320 in sequence, as described herein; a SUSPICION ELEVATED determination does not trigger signature generation at step 517, and no irreversible projection is performed. At step 518, federated geometric coordination channel 140 receives aggregated geometric invariants derived from the intrusion determination, including the attack class, response level, and federation confidence level associated with the determination, and transmits these invariants to peer nodes in the federation; no cognitive content, geometric stress profile, attack payload, or manifold coordinate is transmitted at step 518, preserving the architectural guarantee that federation does not expose the cognitive structure or security history of the present node to peer nodes.

At step 519, the method tightens the detection sensitivity of geometric intrusion detection module 160 via the admission control feedback path 290. The feedback signal transmitted through path 290 causes compositional intrusion assessor 260 to apply reduced persistence thresholds and increased cross-signal correlation weights during the monitoring cycles that follow the issuance of a determination at step 513 or step 514, such that the detection sensitivity of module 160 adapts dynamically to the current security context. Tightened detection sensitivity allows module 160 to detect renewed or escalating adversarial activity more rapidly during and following an active mitigation response than it would under baseline sensitivity conditions, and to transition from a SUSPICION ELEVATED determination to an INTRUSION CONFIRMED determination more quickly when the evidence pattern is consistent with a continuing or escalating attack. The tightening applied at step 519 is reversible and is relaxed by mitigation response coordinator 400 as the active response level transitions toward the Recovery and Relaxation level 403 upon signal from recovery monitor 480.

At decision 520, the method determines whether the monitoring cycle is to continue. If the monitoring cycle is to continue, which may be the case during all normal operation of the persistent cognitive machine, the method proceeds along the YES branch returning to step 501 to begin the acquisition of geometric signals for the next monitoring cycle. The monitoring cycle repeats continuously, with each cycle performing all steps of the method 500 beginning from step 501, and the tightened detection sensitivity established at step 519 of a preceding cycle remains in effect across subsequent cycles until explicitly relaxed by the mitigation response coordinator 400. If the monitoring cycle is not to continue, for example, upon intentional shutdown of the persistent cognitive machine or explicit deactivation of the geometric intrusion detection module 160, the method proceeds along the NO branch at which the method terminates. The continuous monitoring character of the method 500 ensures that the persistent cognitive machine is under active geometric surveillance at all times during normal operation, and that the latency between the onset of adversarial geometric influence and the issuance of a detection determination is bounded by the duration of a single monitoring cycle rather than by the accumulation of behavioral evidence over extended operational periods.

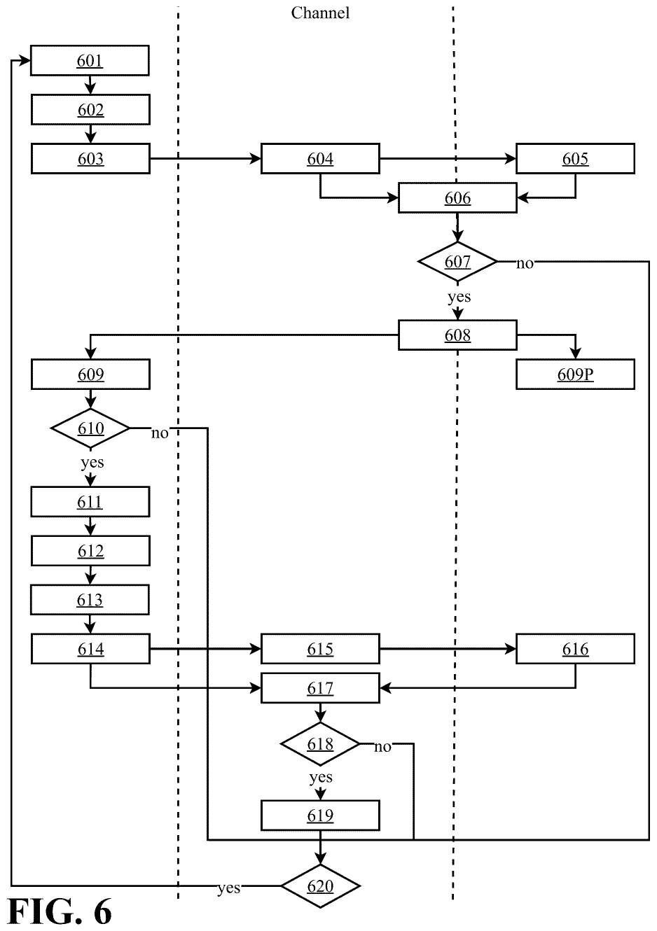

FIG. 6 is a flow diagram of an exemplary method 600 for federated geometric intrusion detection across a multi-node federation of persistent cognitive machines, according to an embodiment. The method 600 illustrates the processes by which individual PCM nodes share aggregated geometric invariants without sharing cognitive content, how cross-node geometric divergence is detected at the federation level, how a confirmed intrusion at one node triggers a coordinated defensive posture across the federation, and how durable structural immunity acquired at one node is elevated to a shared federated constraint applicable to all participating nodes. The method 600 is presented in FIG. 6 using a three-lane swim lane architecture in which the leftmost lane represents the processes executed by the local PCM node (that is, any participating node in the federation from whose perspective the method is described, the center lane represents the processes executed through or coordinated by a federated geometric coordination channel 140, and the rightmost lane represents the processes executed by one or more peer nodes participating in the federation. The method 600 described from the perspective of the local node is symmetrically applicable to each node in the federation: each node simultaneously occupies the role of the local node from its own perspective and the role of a peer node from the perspective of other nodes.

According to the embodiment, the process begins step 601, at which the local node executes its local detection cycle by performing the signal acquisition, parallel channel evaluation, and compositional assessment operations described at steps 501 through 510 of method 500 illustrated in FIG. 5. The execution of the local detection cycle at step 601 produces a composite anomaly profile for the current monitoring cycle reflecting the structural state of the local node's cognitive substrate 150 across a plurality of detection channels of geometric intrusion detection module 160. At step 602, the local node generates a local geometric invariant summary by aggregating the current-cycle measurements of the five detection channels into a compact, content-agnostic package encoding the epistemic phase, holonomy, curvature distribution, capacity utilization, and reservoir boundary dynamics of the local node's cognitive substrate. The local geometric invariant summary generated at step 602 does not contain and cannot be used to reconstruct any semantic content, cognitive trajectory, task knowledge, attack payload, or other information about the local node's cognitive substrate beyond the aggregated geometric indicator values themselves. At step 603, the local node transmits the local geometric invariant summary to federated geometric coordination channel 140 via a cross-lane transmission to the center lane of FIG. 6. This transmission occurs regardless of whether the composite anomaly profile produced at step 601 exhibits anomalous indicators, such that the federation continuously receives baseline geometric indicator data from all nodes during normal operation and does not receive geometric invariant summaries only when anomalies are present, which would itself constitute an anomaly signal.

At step 604, federated geometric coordination channel 140 receives and aggregates the local geometric invariant summaries transmitted by all participating nodes in the current cycle, constructing a federation-wide baseline envelope encoding the aggregate range of geometric indicator values across all nodes. The federation-wide baseline envelope constructed at step 604 reflects the expected range of normal geometric variation across the federation, including, but not limited to, node-level differences arising from differences in task domain, operational history, and substrate configuration, and serves as the reference against which individual node deviations are evaluated at the cross-node comparison step 606. At step 605, each peer node receives the aggregated invariant packages assembled by channel 140 and uses them to update its local federated baseline envelopes as maintained by federated baseline comparator 263 of its geometric intrusion detection module 160. The updated federated baseline envelopes are additionally returned to the local node, enabling a federated baseline comparator 263 of the local node to incorporate the peer-node baseline data into the local composite anomaly assessment performed at step 609. The exchange of aggregated geometric invariants at steps 603 through 605 enables each node to evaluate its own geometric indicators against a multi-node reference context rather than solely against its own historical baselines, without any node exposing its cognitive content or security history to the federation.

At step 606, spanning the center and right lanes of FIG. 6, federated geometric coordination channel 140 and the peer nodes collectively perform a cross-node geometric comparison by evaluating the invariant packages received from all nodes against one another and against the federation-wide baseline envelope, identifying divergence patterns consistent with localized compromise of one or more nodes, with coordinated multi-node attacks targeting several nodes simultaneously, or with cross-node epistemic desynchronization in which one or more nodes exhibit anomalous geometric divergence from the federation as a whole. At decision 607, the method determines whether cross-node divergence meeting the divergence detection threshold has been identified at step 606. If cross-node divergence is not detected, the method proceeds along the NO branch descending to the cycle continuation decision 620 without issuing any divergence signal; the cross-node comparison performed at step 606 thus produces a null result that does not influence the local node's composite anomaly assessment at step 609. If cross-node divergence is detected, the method proceeds along the YES branch to step 608, at which federated geometric coordination channel 140 generates a cross-node divergence signal encoding the divergence class, the inter-node divergence magnitude, the subset of affected nodes, and the federation confidence level associated with the divergence detection. The cross-node divergence signal is routed to both the local node, where it is received at step 609, and to the peer nodes, where it is received at the peer nodes' counterpart to step 609, designated as step 609P.

At step 609, the local node updates its composite anomaly assessment by incorporating the cross-node divergence signal received from federated geometric coordination channel 140 at step 608 into the composite anomaly profile produced during the local detection cycle at step 601. The incorporation of the cross-node divergence signal into the composite anomaly assessment implements the architectural property that federated baseline comparator 263 of the local node's compositional intrusion assessor 260 may cause the composite anomaly threshold to be exceeded on the basis of federation-level divergence alone, even if no individual detection channel of the local node has independently exceeded its local anomaly threshold, as described herein. At decision 610, the method determines whether the updated composite anomaly assessment exceeds the local anomaly threshold. If the local anomaly threshold is not exceeded, the method proceeds along the NO branch to the cycle continuation decision 620, without issuing a local intrusion determination. This NO branch covers the case in which the cross-node divergence signal caused the local node's composite anomaly to increase but not to exceed the threshold, reflecting the architectural property that cross-node divergence is an input to the composite anomaly assessment rather than an independent determination trigger; the final determination authority remains with the local node's intrusion classification and decision unit 270. If the local anomaly threshold is exceeded, the method proceeds along the YES branch to step 611.

At step 611, the intrusion classification and decision unit 270 of the local node issues an intrusion determination of either INTRUSION CONFIRMED or SUSPICION ELEVATED, classified by geometric attack type, as described at steps 513 and 514 of the method 500 illustrated in FIG. 5. The determination issued at step 611 may be based in whole or in part on the cross-node divergence signal incorporated at step 609, and when the triggering anomaly is attributable to cross-node divergence, the geometric attack type classification issued at step 611 will include or consist of a cross-node epistemic desynchronization classification. At step 612, the local node initiates a local mitigation response through the geometric control and mitigation engine 180 at the response level and with the mechanism combination corresponding to the determination and attack type classification issued at step 611, as described herein. At step 613, if and only if the determination issued at step 611 is INTRUSION CONFIRMED, the epistemic intrusion signature store 170 generates an epistemic intrusion signature for the detected intrusion by executing the content stripping, geometric encoding, non-invertible compression, and irreversible projection operations described herein; when the triggering anomaly is attributable in whole or in part to cross-node divergence, the generated signature is classified as a federated and cross-node-class signature 334 with a constraint scope indicator set to reflect candidate federated elevation upon peer confirmation. At step 614, the local node transmits the intrusion determination status (e.g., encoding the attack class, response level, and confidence level) to the federated geometric coordination channel 140 via a cross-lane transmission; no cognitive content, geometric stress profile, affected substrate regions, or other detail about the local node's cognitive structure or security history is included in this transmission.

At step 615, the federated geometric coordination channel 140 receives the intrusion determination status transmitted at step 614 and relays the abstracted intrusion status to the peer nodes, again transmitting only the geometric invariant representation of the determination (e.g., attack class, response level, and confidence level) without any attack detail or manifold coordinate information. At step 616, each peer node receives the relayed intrusion status from the channel 140 and responds by executing one or more of the following: elevating its local detection sensitivity by reducing the persistence thresholds and increasing the cross-signal correlation weights of its compositional intrusion assessor 260; engaging the Suspicion Elevated response level 401 of its mitigation response coordinator 400, which causes its epistemic admission controller 430 to tighten admission criteria at its external interface and input projection component 190; tightening admission criteria through its admission controller 430 in the specific respects corresponding to the received attack class classification; and priming its federated elevation stage 343 of its signature lifecycle manager 340 to evaluate whether locally stored signatures of the corresponding attack class satisfy the peer confirmation threshold for federated elevation in light of the received confirmation. The responses executed by peer nodes at step 616 implement the architectural principle that structural immunity acquired by one node through confirmed adversarial experience propagates across the federation as a coordinated defensive posture, before adversarial activity reaches any peer node, without any peer node needing to independently confirm the intrusion through its own detection channels in order to benefit from the local node's security learning.

Following step 616, the paths from the local node and from the peer nodes converge in the center lane of FIG. 6 at step 617, at which the signature lifecycle manager 340, acting through its federated elevation stage 343, evaluates whether the peer confirmations received in connection with the intrusion determination issued at step 611 satisfy the peer confirmation threshold for federated elevation of the corresponding epistemic intrusion signature. The peer confirmation threshold requires that a specified number or proportion of peer nodes have independently confirmed, through their own detection cycles, geometric violations consistent with the same attack class as the intrusion detected at the local node; a single node's confirmation, even with high confidence, does not suffice to trigger federated elevation. At decision 618, the method determines whether the peer confirmation threshold has been met. If the threshold is not met, the method proceeds along the NO branch: the epistemic intrusion signature generated at step 613 remains a local constraint applicable only to the local node's admissibility structure, as represented by the note box on the NO branch of decision 618 in FIG. 6, and the method descends to the cycle continuation decision 620. If the peer confirmation threshold is met, the method proceeds along the YES branch to step 619, at which the federated elevation stage 343 elevates the local epistemic intrusion signature to a federated constraint and distributes the elevated constraint to all participating nodes through the channel 140. The distribution at step 619 transmits only the elevated admissibility constraint (e.g., encoding the attack class, constraint scope, and federation confidence level of the elevated signature) without transmitting the geometric stress profile, substrate coordinates, or any other detail derivable from the cognitive structure of the local node. Upon receipt of the elevated constraint, each peer node applies it to its local admissibility structure 150 through its admissibility constraint emitter 350, and the local node simultaneously applies the constraint to its own admissibility structure, implementing the architectural property that federated elevation distributes structural immunity uniformly across the federation without distributing cognitive exposure.

Following the completion of the applicable steps in each cycle—whether the cycle concluded at the NO branch of decision 607, the NO branch of decision 610, the NO branch of decision 618, or the completion of step 619—the method converges at decision 620, at which the method determines whether the federation cycle is to continue. If the federation cycle is to continue (which is the case during all normal operation of the participating nodes) the method proceeds along the YES branch, illustrated with a dashed line along the left margin of FIG. 6, returning to step 601 to begin the next federation detection cycle. The continuous cycling of the method 600 ensures that the federation-wide baseline envelope maintained by the channel 140 is updated at each cycle with fresh geometric invariant summaries from all nodes, that cross-node divergence is evaluated at each cycle against an up-to-date baseline, and that the detection sensitivity of each individual node is continuously informed by the current geometric context of the entire federation rather than only by the node's own local history. The elevated detection sensitivity and tightened admission criteria established at peer nodes following a confirmed intrusion at the local node at steps 615 and 616 remain in effect across subsequent cycles until relaxed by each peer node's mitigation response coordinator 400 upon signal from its recovery monitor 480 that geometric indicators have returned to within-envelope conditions. If the federation cycle is not to continue, for example, upon intentional shutdown of the federated geometric intrusion detection system 100, the method proceeds along the NO branch to step 621, at which the method terminates.

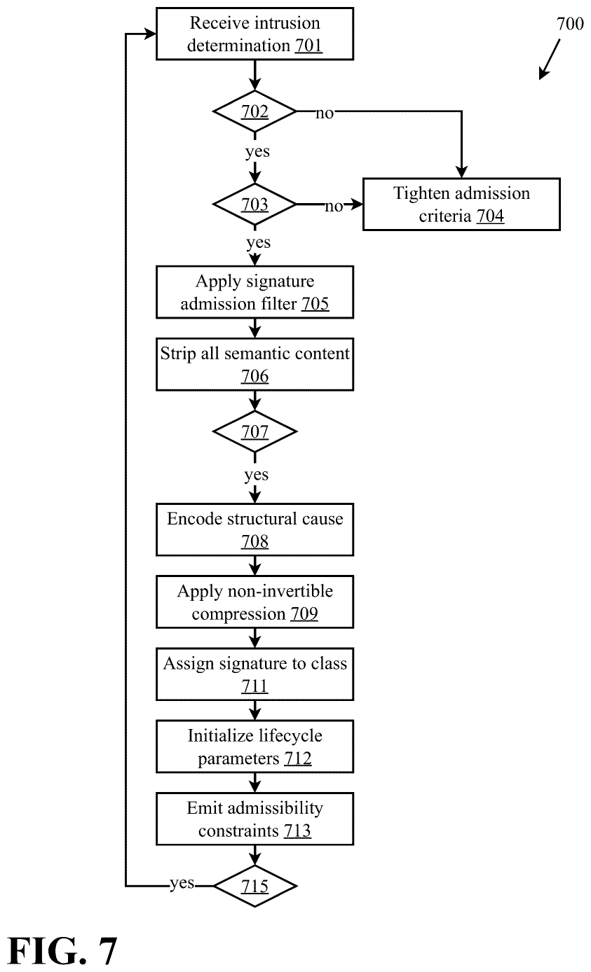

FIG. 7 is a flow diagram of an exemplary method 700 of learning from intrusion without content poisoning, according to an embodiment. The method 700 illustrates the process by which a persistent cognitive machine acquires durable structural immunity from adversarial experience—in the form of admissibility constraints that suppress future geometric violations of the same class—without incorporating any adversarial content, attack payload, or semantic information derived from the adversarial interaction into the task knowledge structures of the cognitive substrate 150. The method 700 is distinguished from adversarial training and related approaches by multiple properties that are preserved throughout every stage of the method: the task learning substrate is never contacted by the security learning path; all processing after the content stripping stage operates exclusively on geometric structure with no semantic content present; and the structural immunity acquired through the method influences future cognitive operations solely through admissibility constraints on trajectory selection, not through modification of the semantic content of knowledge in the irreversible reservoirs of the cognitive substrate 150.

According to the embodiment, the process begins at step 701, at which the epistemic intrusion signature store 170 receives from the intrusion detection output bus 280 the intrusion determination, geometric stress profile, attack type classification, and confidence level produced by the intrusion classification and decision unit 270 of the geometric intrusion detection module 160 for the current monitoring cycle. Task learning continues normally during step 701 and during all subsequent steps of the method 700; the receipt of the intrusion determination at step 701 does not gate, interrupt, or condition the ongoing task learning operations of the cognitive substrate 150. At decision point 702, the method determines whether the intrusion determination received at step 701 is an INTRUSION CONFIRMED determination. If the determination is SUSPICION ELEVATED rather than INTRUSION CONFIRMED, the method proceeds along the NO branch to step 704, at which the epistemic admission controller 430 of the geometric control and mitigation engine 180 tightens admission criteria at the external interface and input projection component 190 in the respects corresponding to the attack type associated with the SUSPICION ELEVATED determination, without initiating any signature generation activity and without causing any irreversible modification to the epistemic intrusion signature store 170. If the determination is INTRUSION CONFIRMED, the method proceeds from decision 702 to decision point 703, at which the method determines whether the geometric stress profile received at step 701 satisfies the persistence threshold of the signature admission filter 300. The persistence threshold requires that the anomalous geometric indicators underlying the INTRUSION CONFIRMED determination have been present continuously over a sufficient structural period to exclude transient stress events that, while meeting the multi-channel corroboration criterion of the intrusion classification and decision unit 270, may not reflect a sustained adversarial influence warranting durable signature generation. If the persistence threshold is not met, the method again proceeds along the NO branch to step 704, applying tightened admission criteria without signature generation. The conservatism of the two-stage pre-filter at decisions 702 and 703 is deliberate: because signature generation produces an irreversible modification to the non-navigable signature repository 330, the method accepts the risk of delayed signature generation over the risk of false-positive signature accumulation.

If both decisions 702 and 703 yield YES results, the method proceeds into the multi-stage signature generation and lifecycle pipeline beginning at Stage I. At step 705, constituting Stage I of the pipeline and corresponding to the signature admission filter 300 of the epistemic intrusion signature store 170, the method applies a final admission gate confirming that both conditions—INTRUSION CONFIRMED determination and persistence threshold satisfied—are concurrently present before authorizing the security learning pipeline to proceed. Step 705 is architecturally significant because it is the last point at which the method has access to the full geometric stress profile, including the attack type classification and the localization of the anomalous geometric indicators within the cognitive substrate 150; subsequent stages of the pipeline operate only on progressively more abstracted and compressed representations from which the original stress profile cannot be recovered. The right-lane annotation corresponding to step 705 notes that adversarial training approaches would, at an equivalent processing stage, expose the task learning substrate to adversarial examples by incorporating attack content into the representational learning process; the method 700 forecloses this exposure structurally by routing the adversarial experience exclusively through the security learning pipeline from this point forward, with the separation barrier 360 preventing any contact between the security learning path and the task learning substrate.

At step 706, constituting Stage II of the pipeline and corresponding to the content stripping stage 311 of the geometric stress abstraction unit 310, the method discards all semantic content associated with the adversarial interaction, including the attack payload, the specific input sequences that produced the detected geometric stress, any semantic content of the adversarial inputs or outputs, the cognitive trajectory details traversed during the adversarial interaction, and any domain-specific information that could be used to characterize the adversarial interaction in semantic terms. What is retained after step 706 is exclusively the structural cause of the detected geometric stress: the geometric perturbation pattern that the adversarial interaction produced on the cognitive substrate 150, abstracted from all information about what the adversarial input contained, what the adversarial interaction was directed at semantically, or what the intended effect of the adversarial interaction was. The right-lane annotation corresponding to step 706 identifies Stage II as the primary enforcement point of the separation barrier 360: all content discarded at step 706 is permanently unavailable to the security learning path in all subsequent stages, and the task learning substrate remains uncontacted. At decision point 707, the method determines whether the structural cause of the detected geometric stress is recoverable from the retained geometric perturbation pattern in sufficient form to support geometric encoding at Stage III. If the structural cause is not recoverable, for example, because the detected anomaly was insufficiently localized to yield a specific geometric stress pattern after content stripping, the method proceeds along the NO branch, illustrated with a dashed line along the left margin of FIG. 7, abandoning signature generation for the current cycle and descending to the cycle continuation decision 715. If the structural cause is recoverable, the method proceeds to Stage III.

At step 708, constituting Stage III of the pipeline and corresponding to the geometric encoding stage 312 of the geometric stress abstraction unit 310, the method encodes the structural cause of the detected geometric stress retained from Stage II as a geometric representation comprising one or more of the following components, depending on the attack type classification: the magnitude and directional character of the phase drift detected along adversarially influenced cognitive trajectories; the curvature imbalance pattern reflecting the distribution of adversarial epistemic strain across the sectors of the cognitive substrate; the capacity stress profile reflecting the temporal dynamics and localization of capacity anomalies induced by the adversarial interaction; and the boundary defect pattern reflecting the localization and character of reservoir boundary stress associated with the adversarial interaction. The geometric representation produced at step 708 may be classified by geometric attack type to determine the signature class to which it will be assigned at Stage VI. No semantic feature extraction is performed at step 708: the encoding operation takes as its input only the geometric perturbation pattern retained from Stage II and produces as its output only a geometric representation of that pattern, without querying, accessing, or modifying the task knowledge structures of the cognitive substrate 150. The geometric representation produced at step 708 carries no information about what the adversarial input contained or what the adversarial interaction was intended to accomplish: it encodes only how the cognitive substrate was structurally perturbed, not why or by what.

At step 709, constituting Stage IV of the pipeline and corresponding to the non-invertible compression stage 313 of the geometric stress abstraction unit 310, the method applies a non-invertible compression operation to the geometric representation produced at Stage III, yielding a compact representation from which the original geometric stress profile cannot be recovered. Non-invertibility at step 709 is a structural guarantee rather than a policy commitment: the compression operation is designed such that no inversion procedure, applied to the compressed representation with any level of computational resources, can recover the original stress profile or any information about the specific adversarial interaction from which the representation was derived. The compact representation produced at step 709 retains sufficient geometric structure to support the admissibility constraint emission functions of Stage VII—specifically, it encodes the geometric invariants of the attack class that are necessary and sufficient to suppress future geometric violations of the same class through trajectory admission control—while discarding the geometric specifics of the particular adversarial interaction from which the signature was derived. Non-invertibility at step 709 provides a second, independent structural guarantee that the security learning pipeline cannot be used to reconstruct adversarial content or re-expose the cognitive substrate 150 to the adversarial interaction, complementing the content stripping performed at Stage II. The task learning substrate remains uncontacted at step 709.

At step 710, constituting Stage V of the pipeline and corresponding to the irreversible projection operator 320 of the epistemic intrusion signature store 170, the method projects the compact representation produced at Stage IV into the non-navigable signature repository 330 via a non-invertible projection operation structurally analogous to the irreversible curvature consolidation mechanism of the architecture. Step 710 constitutes a point of permanent, irreversible commitment: once projection into the non-navigable signature repository 330 has occurred, the projected signature cannot be retracted, modified, or reversed through any operation available within the security learning pipeline. The non-navigability of the signature repository 330 means that no admissible cognitive trajectory of the persistent cognitive machine may access, traverse, or retrieve the projected signature: the signature exists within the geometric structure of the cognitive substrate in a form that influences future admissibility evaluations through the admissibility constraint emitter 350 but that cannot be traversed, replayed, or reconstructed into any form of active cognition by the persistent cognitive machine. The right-lane annotation corresponding to step 710 identifies Stage V as the point of permanent enforcement of the security/task learning separation: the projected signature cannot influence the task learning substrate through any mechanism other than the emission of admissibility constraints at Stage VII, which themselves act only on future trajectory selection and not on the semantic content of knowledge structures.

At step 711, constituting the first sub-step of Stage VI of the pipeline and corresponding to the class assignment function of the signature lifecycle manager 340, the method assigns the projected signature to one of the four signature classes of the non-navigable signature repository 330 based on the geometric attack type classification determined at Stage III: phase-class signatures 331 for signatures derived from epistemic phase drift attacks and holonomy poisoning attacks; curvature and holonomy-class signatures 332 for signatures derived from attacks producing curvature imbalance or holonomy inconsistency; capacity and boundary-class signatures 333 for signatures derived from capacity flooding attacks and reservoir boundary probing attacks; and federated and cross-node-class signatures 334 for signatures derived from cross-node epistemic desynchronization attacks or from signatures elevated from peer-node confirmations through the federated elevation stage 343. At step 712, constituting the second sub-step of Stage VI, the signature lifecycle manager 340 initializes the lifecycle parameters governing the ongoing management of the projected signature, including: the initial influence strength of the signature as emitted through the admissibility constraint emitter 350; the scope of the signature, specifying whether it applies as a local constraint to the present node only or as a candidate for federated elevation upon peer confirmation; the reinforcement sensitivity governing the degree to which repeated geometric violations of the same class strengthen the signature's influence through the reinforcement stage 341; the decay rate governing the rate at which the signature's influence strength diminishes in the absence of corroborating adversarial activity through the decay stage 342; and the relaxation conditions specifying the geometric and temporal criteria that must be satisfied before the signature's influence strength is deliberately reduced through the controlled relaxation stage 344. Together, steps 711 and 712 establish the long-term management framework governing how the structural immunity acquired through the current adversarial experience will evolve over the operational lifetime of the persistent cognitive machine.

At step 713, constituting Stage VII of the pipeline and corresponding to the admissibility constraint emitter 350 of the epistemic intrusion signature store 170, the method emits the initial active admissibility constraints derived from the projected and lifecycle-initialized signature to three downstream consumers in parallel. The first consumer is the geometric control and mitigation engine 180, which receives active constraint signals encoding the geometric class of adversarial influence against which the signature provides protection and uses these signals to calibrate its ongoing mitigation posture through the mitigation response coordinator 400. The second consumer is the cognitive substrate 150 itself, which receives admissibility conditioning signals that modify the admissibility criteria applied to future cognitive trajectories in the vicinity of the geometric regions identified as susceptible to the attack class encoded by the signature, such that trajectories exhibiting geometric characteristics consistent with the encoded adversarial influence class are rejected or rerouted before they can produce the epistemic phase, curvature, capacity, or boundary effects that the adversarial interaction exploited. The third consumer is the federated geometric coordination channel 140, which receives abstracted constraint signals encoding the attack class and constraint scope of the signature for relay to peer nodes through the federated elevation evaluation pathways described herein. The right-lane annotation corresponding to step 713 identifies the mode of action of the emitted constraints as the final enforcement of the separation barrier 360 at the output of the security learning pipeline: the admissibility constraints emitted at step 713 influence the selection of future cognitive trajectories within the cognitive substrate 150 without altering the semantic content of any knowledge structure stored in the irreversible reservoirs of the cognitive substrate, and the task learning operations of the cognitive substrate continue on an unmodified knowledge substrate throughout and after step 713. The structural immunity acquired through the method 700 therefore manifests exclusively as a geometric property of the admissibility structure of the persistent cognitive machine—as a restriction on which cognitive trajectories are accessible—rather than as a modification of what the persistent cognitive machine knows.

Following the completion of step 713 and the convergence of all earlier exit paths (including the admission-tightening-only path from step 704 and the signature-generation-abandoned path from decision 707) the method proceeds to decision 715, at which the method determines whether the monitoring cycle is to continue. If the monitoring cycle is to continue, the method proceeds along the YES branch returning to step 701 to receive the intrusion determination for the next monitoring cycle. The method 700 thus executes once per monitoring cycle, processing the intrusion determination produced by each cycle of the local detection method and advancing to signature generation only when both pre-filter conditions at decisions 702 and 703 are satisfied. The admissibility constraints emitted at step 713 in one cycle remain active and continue to be applied by the admissibility constraint emitter 350 in subsequent cycles, with their influence strength evolving under the lifecycle management of the signature lifecycle manager 340 independently of the detection and signature generation operations of subsequent cycles. If the monitoring cycle is not to continue, the method proceeds along the NO branch to step 716, at which the method terminates. The method 700 thereby implements the architectural principle that security is learned geometrically and enforced structurally: each adversarial experience that meets the admission criteria produces a durable modification to the admissibility structure of the persistent cognitive machine, without modifying the cognitive substance of what the machine knows, and without exposing the machine's knowledge structures to the adversarial content that prompted the learning.

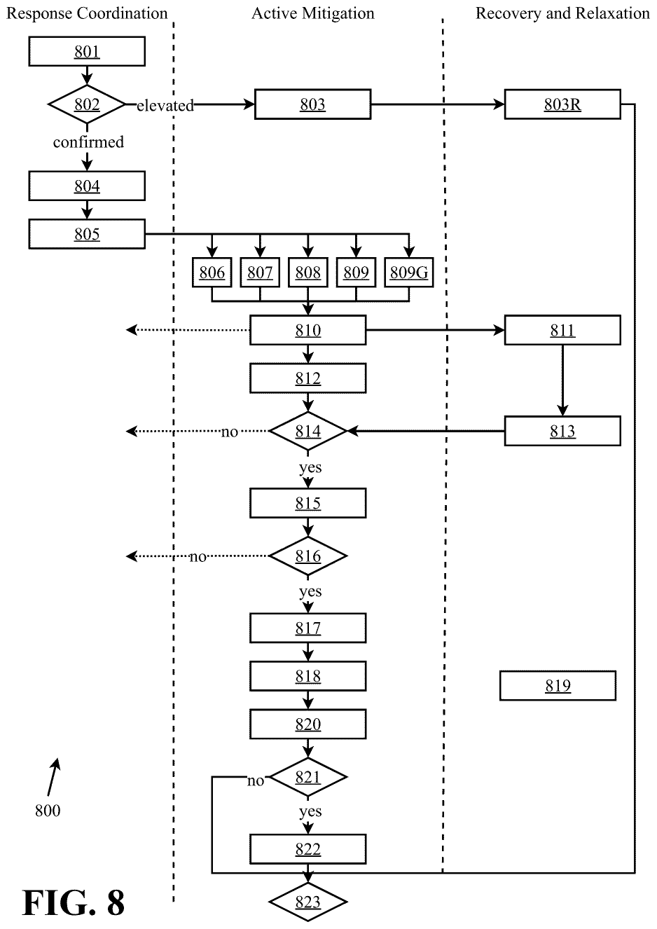

FIG. 8 is a flow diagram of an exemplary method 800 of intrusion response and recovery, according to an embodiment. The method 800 illustrates the full response and recovery lifecycle of the geometric control and mitigation engine 180, from receipt of an intrusion determination through graduated response activation, parallel execution of five mitigation mechanism types, recovery monitoring, staged relaxation, and retention of durable structural lessons, including the initiation of federated signature elevation where appropriate. The method 800 is presented in FIG. 8 using a three-lane swim lane architecture. The leftmost lane, designated Response Coordination, contains the processes executed by the mitigation response coordinator 400 and includes the determination-level decision, response level engagement, operational continuity annotations, and cycle-level coordination functions. The center lane, designated Active Mitigation, contains the parallel execution of the five mitigation mechanisms 806 through 809G, the substrate sector application step 810, detection sensitivity tightening 812, and the recovery and relaxation phase steps 815 through 822. The rightmost lane, designated Recovery and Relaxation, contains the processes executed by the recovery monitor 480 and the signature lifecycle manager 340, including geometric indicator monitoring, federated response status transmission 811, and signature lifecycle update 819.

According to the embodiment, the process begins at step 801, at which the mitigation response coordinator 400 receives, from the intrusion detection output bus 280, the intrusion determination, geometric stress profile, attack type classification, and confidence level produced by the geometric intrusion detection module 160 for the current monitoring cycle, together with the active admissibility constraint signals currently being emitted by the admissibility constraint emitter 350 of the epistemic intrusion signature store 170. The active admissibility constraints received from the signature store 170 at step 801 inform the mechanism combination selected by the mitigation response coordinator 400 at step 804, enabling the coordinator to calibrate the active mitigation posture to the attack class associated with the current determination in light of the structural immunity already encoded in the signature store. At decision point 802, the mitigation response coordinator 400 determines the level of the received intrusion determination. If the determination is SUSPICION ELEVATED, the method proceeds along the SUSPICION ELEVATED branch to step 803. If the determination is INTRUSION CONFIRMED, the method proceeds along the INTRUSION CONFIRMED branch to step 804.

At step 803, the mitigation response coordinator 400 engages the Suspicion Elevated response level 401 of the geometric control and mitigation engine 180. The Suspicion Elevated response level 401 causes the epistemic admission controller 430 to tighten admission criteria at the external interface and input projection component 190 in the respects corresponding to the attack type associated with the SUSPICION ELEVATED determination, and causes the geometric intrusion detection module 160 to heighten monitoring frequency and reduce persistence thresholds for the detection channels most relevant to the associated attack type. The Suspicion Elevated response level 401 does not activate geometric quarantine, reservoir boundary reinforcement, or structural isolation actions; it is a preparatory and admissibility-tightening response that preserves normal cognitive operation in all regions of the cognitive substrate 150 while increasing the sensitivity of the system to renewed or escalating adversarial activity. At step 803R, the recovery monitor 480 monitors geometric indicators at elevated frequency, evaluating whether the anomalous indicators underlying the SUSPICION ELEVATED determination resolve spontaneously, persist at their current level, or escalate toward the threshold for an INTRUSION CONFIRMED determination. If escalation to INTRUSION CONFIRMED is detected during the monitoring period at step 803R, the mitigation response coordinator 400 transitions directly to the INTRUSION CONFIRMED response level 402 without waiting for the current cycle to conclude. If escalation is not detected, the SUSPICION ELEVATED path continues to join the cycle continuation decision point 823 at the conclusion of the current cycle.

At step 804, the mitigation response coordinator 400 engages the Intrusion Confirmed response level 402 of the geometric control and mitigation engine 180 and calibrates the combination of mitigation mechanisms to be activated based on the attack type classification received at step 801. The calibration performed at step 804 ensures that the mitigation response is targeted to the specific class of geometric violation identified by the detection module 160: a phase drift attack activates mechanisms directed at phase coherence and trajectory admission control; a capacity flooding attack activates mechanisms directed at density limits and consolidation blocking; a reservoir boundary probing attack activates barrier elevation and interior isolation mechanisms; a cross-node epistemic desynchronization attack activates both local quarantine and federated coordination mechanisms. At step 805, the mitigation response coordinator 400 dispatches control signals to the relevant mitigation mechanisms through the mitigation dispatch bus 410. The cognitive substrate 150 remains operational throughout the execution of steps 806 through 812: the mitigation actions dispatched at step 805 are localized to the regions of the cognitive substrate identified as structurally compromised by the detected intrusion, and regions of the cognitive substrate not implicated in the detected intrusion continue normal reasoning and task learning operations with their knowledge structures intact and accessible throughout the active mitigation period.

Steps 806 through 809G execute in parallel upon receipt of dispatch signals from the mitigation dispatch bus 410, each constituting the activation of one of the five mitigation mechanisms of the geometric control and mitigation engine 180 at the intensity level determined by the coordinator 400 at step 804. At step 806, the geometric quarantine manager 420 applies traversal restrictions limiting cognitive trajectory access to geometrically compromised regions of the active sector 491 of the cognitive substrate, suspends consolidation of representations in affected regions to prevent adversarial geometric influence from propagating into irreversible knowledge structures, and reroutes reasoning trajectories around quarantined regions to maintain cognitive throughput in unaffected regions. At step 807, the epistemic admission controller 430 applies four dimensions of admission tightening at the external interface and input projection component 190: elevating projection thresholds to require stronger evidentiary support for new representations to enter the active sector; requiring higher phase coherence of incoming trajectories before admission; increasing the evidentiary burden associated with inputs exhibiting geometric characteristics consistent with the detected attack class; and reducing the tolerance for curvature imbalance in admitted projections. At step 808, the capacity hardening unit 440 applies density limits restricting the rate of new representational accumulation in affected regions, defers abstraction operations that would otherwise compress active representations into irreversible forms, and blocks consolidation processes that could permanently encode adversarially influenced representational structure into the irreversible reservoirs of the cognitive substrate. At step 809, the reservoir boundary reinforcement unit 450 elevates barrier energy levels at the boundaries of irreversible reservoirs in affected regions, strengthens corroboration requirements for boundary-crossing events, and isolates the interior of challenged reservoir regions from external influence during the active mitigation period, drawing on boundary-class signatures 333 from the epistemic intrusion signature store 170 to calibrate the specific barrier reinforcement profile. At step 809G, the intrusion-aware output gate 460 suppresses outputs derived from geometrically compromised regions of the cognitive substrate, signals elevated uncertainty in outputs derived from regions adjacent to compromised areas, and reduces confidence scores associated with reasoning trajectories that traversed affected regions during the active mitigation period. At step 810, the control signals from the five parallel mechanisms converge through the substrate control bus 470 and are applied to the four sectors of the cognitive substrate interface 490: the active sector 491 receives quarantine traversal restrictions and admission tightening signals; the boundary sector 492 receives barrier reinforcement and corroboration strengthening signals; the irreversible sector 493 receives consolidation blocking and interior isolation signals; and the external interface sector 494 receives projection threshold elevation and curvature imbalance tolerance reduction signals from the epistemic admission controller 430.

At step 811, the federated response coordinator 495 transmits the active response status—encoding the attack class, response level, and federation confidence level associated with the current mitigation engagement—to peer nodes through the federated geometric coordination channel 140. The transmission at step 811 enables peer nodes to engage preparatory defensive postures as described herein, without the local node sharing any cognitive content, geometric stress profile detail, or information about the specific attack payload associated with the current intrusion. A dashed feedback arrow from step 810 back to the response coordination lane in FIG. 8 represents the admission control feedback path 290, through which the active mitigation controls applied at step 810 cause a corresponding tightening of the detection sensitivity of the geometric intrusion detection module 160, as described herein. At step 812, the detection sensitivity tightening is confirmed as applied, reducing persistence thresholds and increasing cross-signal correlation weights in the compositional intrusion assessor 260 for the duration of the active mitigation response. At step 813, the recovery monitor 480 initiates and maintains continuous evaluation of geometric indicators across all five detection channels of the geometric intrusion detection module 160, comparing current-cycle geometric indicator values against within-envelope conditions representing the expected range of geometric variation in the absence of active adversarial influence. The recovery monitor 480 transmits its findings via the recovery feedback path 481 to the mitigation response coordinator 400 and to the within-envelope decision 814 and to the signature lifecycle update step 819. At decision 814, the method determines whether the geometric indicators have returned to within-envelope conditions and have remained there continuously over a period sufficient to indicate genuine stabilization rather than transient remission. If within-envelope conditions have not been sustained—for example, because anomalous indicators persist, because new anomalous indicators emerge in adjacent regions, or because within-envelope conditions are achieved only transiently before the anomalous indicators return—the method proceeds along the NO branch, illustrated with a dashed line returning to the left lane annotation area, and the active mitigation controls engaged at steps 806 through 810 remain in force for the next monitoring cycle without modification. If within-envelope conditions have been sustained, the method proceeds along the YES branch to the recovery and relaxation phase.

Upon entry into the recovery and relaxation phase, the mitigation response coordinator 400 transitions from the Intrusion Confirmed response level 402 to the Recovery and Relaxation level 403, instructing all active mitigation mechanisms to begin incremental relaxation of their controls. At step 815, the method initiates graduated relaxation of the active mitigation controls, lifting controls in stages with geometric indicator monitoring performed by the recovery monitor 480 between each stage to verify that the partial relaxation does not cause geometric indicators to exceed within-envelope thresholds. The graduated character of the relaxation implemented at step 815 distinguishes the recovery process of the method 800 from abrupt termination of mitigation: rather than removing all active controls simultaneously upon satisfaction of the within-envelope criterion at decision 814, the method removes them progressively, re-evaluating geometric stability after each incremental relaxation before proceeding to the next. At decision 816, the recovery monitor 480 feeds its current indicator evaluation to the determination of whether geometric indicators remain stable following the most recent incremental relaxation step. If indicators are not stable—indicating that the partial relaxation of controls has allowed adversarial geometric influence to resume or that the cognitive substrate has not fully recovered structural integrity in the affected regions—the method proceeds along the NO branch, illustrated with a dashed line returning up the left margin of FIG. 8 to re-engage the Intrusion Confirmed response level 402 at the coordinator 400 without requiring a new intrusion determination from the geometric intrusion detection module 160: the coordinator 400 re-escalates based on the recovery monitor's indicator feed alone, treating the instability during relaxation as sufficient evidence of continued compromise. If indicators are stable, the method proceeds along the YES branch to step 817. At step 817, the method completes the full relaxation of quarantine controls and admission control adjustments, restoring traversal access across all quarantined regions that have achieved stable within-envelope geometric indicators and restoring baseline detection sensitivity to the geometric intrusion detection module 160 by relaxing the tightened persistence thresholds and correlation weights applied at step 812. At step 818, the geometric quarantine manager 420 evaluates the previously quarantined regions of the cognitive substrate for monitored reintegration, restoring traversal access to regions that have achieved stable within-envelope geometric indicators while maintaining restricted access to any regions that continue to exhibit residual anomalous indicators, and confirming the restoration of normal consolidation and reasoning pathway access in reintegrated regions.

At step 819, the signature lifecycle manager 340 updates the lifecycle parameters of all signatures in the non-navigable signature repository 330 that are associated with the attack class of the current or recently concluded intrusion response, incorporating the recovery monitor's indicator data as input to the reinforcement stage 341, the decay stage 342, the federated elevation stage 343, and the controlled relaxation stage 344 of the lifecycle manager 340. The lifecycle update at step 819 reinforces the influence strength of signatures whose corresponding attack class was confirmed during the current intrusion response and adjusts decay rates and relaxation conditions based on the duration and severity of the geometric stress observed by the recovery monitor 480 throughout the active mitigation period. At step 820, the method confirms that the active admissibility constraints being emitted through the admissibility constraint emitter 350 of the epistemic intrusion signature store 170 remain active following the full relaxation of all other mitigation controls completed at steps 817 and 818. Step 820 implements the architectural property that the structural immunity acquired through the security learning methods described herein persists independently of and beyond the active mitigation response that produced it: the termination of quarantine, admission tightening, capacity hardening, boundary reinforcement, and output gating controls does not affect the ongoing emission of admissibility constraints from the signature store 170, which continue to condition the admissibility of future cognitive trajectories at the cognitive substrate 150 for the duration specified by the lifecycle parameters established at steps 712 and 819. At decision point 821, the method determines whether the signature generated during the current intrusion response satisfies the criteria for federated elevation as a candidate for distribution to peer nodes as a shared admissibility constraint, based on the peer confirmation status evaluated by the federated elevation stage 343 of the signature lifecycle manager 340. If the signature is not a federated elevation candidate, the method proceeds along the NO branch directly to the cycle continuation decision 823. If the signature satisfies the elevation criteria, the method proceeds along the YES branch to step 822, at which the federated elevation stage 343 initiates federated elevation of the signature through the federated geometric coordination channel 140, as described at steps 617 through 619 of the method 600, distributing the elevated admissibility constraint to all participating nodes in the federation without transmitting the geometric stress profile, cognitive substrate details, or attack content associated with the current intrusion.

Following the completion of step 822 or the NO branch from decision 821, together with the SUSPICION ELEVATED path arriving via the dashed line from step 803R along the right margin of FIG. 8, the method converges at decision 823, at which the method determines whether the monitoring cycle is to continue. If the monitoring cycle is to continue—which is the case during all normal operation of the persistent cognitive machine—the method proceeds along the YES branch returning to step 801 to receive the intrusion determination for the next monitoring cycle. The method 800 thus executes once per monitoring cycle of the method 500, processing each intrusion determination produced by the local detection method and advancing through the active mitigation, recovery, and relaxation phases only when the corresponding decision criteria are met. The mitigation controls engaged during a given cycle remain in force across subsequent cycles until the within-envelope criterion at decision 814 is satisfied, decoupling the duration of active mitigation from the duration of the monitoring cycle: a single detection determination at step 801 may produce an active mitigation engagement that spans many subsequent monitoring cycles, with each subsequent cycle's detection determination processed at step 801 in the context of the already-active mitigation controls. The admissibility constraints confirmed at step 820 continue across cycles independently of active mitigation status, providing a persistent layer of structural defense that accumulates over the operational lifetime of the persistent cognitive machine as successive adversarial experiences each contribute to the durable admissibility constraint profile of the epistemic intrusion signature store 170. If the monitoring cycle is not to continue, the method proceeds along the NO branch at which the method terminates.

In one embodiment, the geometric intrusion detection system 100 operates on a single persistent cognitive machine comprising a single cognitive substrate 150, without participation in a federated network and without any active connection to the federated geometric coordination channel 140. In this embodiment, the geometric intrusion detection module 160, the epistemic intrusion signature store 170, and the geometric control and mitigation engine 180 operate as a complete, self-contained intrusion detection and response system requiring no external node for detection, mitigation, signature generation, or structural immunity acquisition.

In the single-node embodiment, the geometric signal distribution bus 200 distributes geometric signals exclusively from the local cognitive substrate 150 to the five detection channels of the geometric intrusion detection module 160. The epistemic phase monitor 210, holonomy integrity monitor 220, curvature imbalance detector 230, capacity and compression stress monitor 240, and reservoir boundary dynamics monitor 250 each evaluate their respective geometric indicators against locally established baseline envelopes rather than federation-wide envelopes, and the federated baseline comparator 263 of the compositional intrusion assessor 260 operates in a reduced configuration in which peer-node baseline envelopes are unavailable and the cross-node divergence signal produced at step 608 of the method 600 is not generated. The remaining functions of the compositional intrusion assessor 260, cross-signal correlation at step 508, persistence and threshold evaluation at step 509, and composite anomaly threshold evaluation at decision 511, operate without modification in the single-node embodiment.

Four of the five geometric attack classes detectable by the system 100 (e.g., epistemic phase drift attacks, holonomy poisoning, capacity flooding and epistemic denial-of-service, and reservoir boundary probing) are fully detectable in the single-node embodiment without reference to any peer-node baseline. The fifth attack class, cross-node epistemic desynchronization, is by definition not detectable in the single-node embodiment, as it requires divergence among at least two participating nodes to constitute a detectable geometric event. A single-node deployment is accordingly not susceptible to cross-node epistemic desynchronization as an attack vector, and the absence of federated comparison capability does not reduce the detection coverage of the system 100 with respect to the four locally detectable attack classes.

In the single-node embodiment, the epistemic intrusion signature store 170 operates without the federated elevation stage 343 of the signature lifecycle manager 340. Signatures generated through the content stripping stage 311, geometric encoding stage 312, non-invertible compression stage 313, and irreversible projection operator 320 are assigned to the phase-class 331, curvature and holonomy-class 332, or capacity and boundary-class 333 repositories of the non-navigable signature repository 330 and are managed through the reinforcement stage 341, decay stage 342, and controlled relaxation stage 344 of the lifecycle manager 340 without elevation to federated constraints. The admissibility constraint emitter 350 continues to emit active constraints to the geometric control and mitigation engine 180 and to the cognitive substrate 150, and the security and task learning separation barrier 360 is enforced without modification in the single-node embodiment. The structural immunity acquired through the method 700 of FIG. 7 is therefore fully available in the single-node embodiment, with the sole difference that it remains local to the node on which it is acquired rather than being eligible for distribution to peer nodes.

The geometric control and mitigation engine 180 operates without modification in the single-node embodiment, engaging all five mitigation mechanisms (e.g., the geometric quarantine manager 420, epistemic admission controller 430, capacity hardening unit 440, reservoir boundary reinforcement unit 450, and intrusion-aware output gate 460) in response to intrusion determinations issued by the intrusion classification and decision unit 270, subject to the attack type calibration described at step 804 of the method 800 of FIG. 8. The federated response coordinator 495 is inactive in the single-node embodiment, and no federated response status is transmitted. Recovery monitoring, graduated relaxation, and durable lesson retention through the signature store 170 proceed as described at steps 813 through 820 of the method 800 without modification.

The single-node embodiment thereby provides a complete geometric intrusion detection, mitigation, and structural immunity acquisition capability for deployments in which federation is not available, not required, or not permitted by operational constraints, and constitutes a non-limiting embodiment in which the core geometric detection and security learning architecture of the present disclosure is instantiated in its simplest form.

### Exemplary Computing Environment

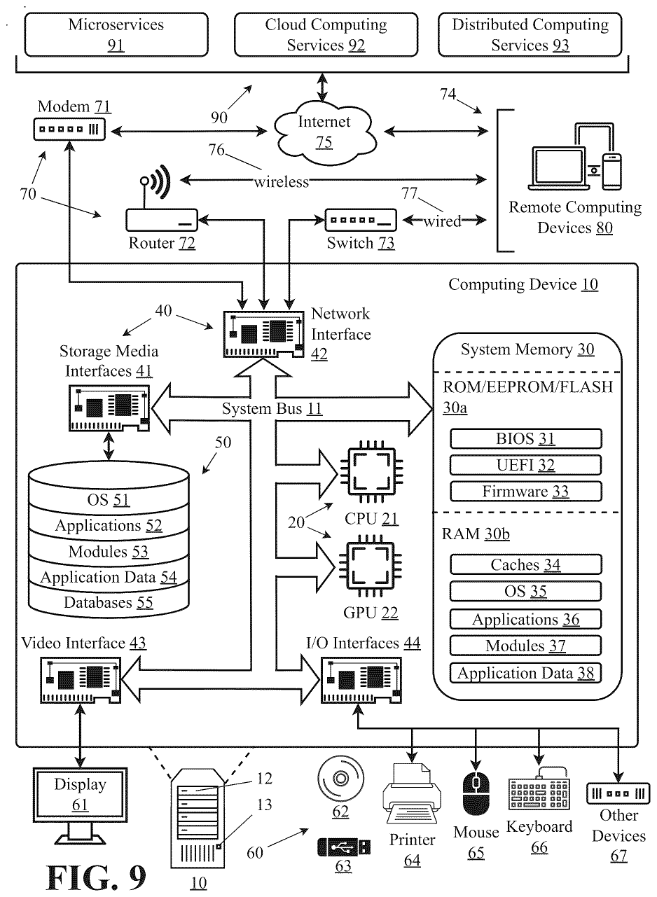

FIG. 9 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer-implemented system for detecting and mitigating adversarial geometric influence on a persistent cognitive machine, comprising a processor and a memory storing instructions that, when executed by the processor, cause the system to:
maintain a cognitive substrate comprising a structured geometric space whose geometry persists across interactions and is reshaped by accumulated experience;
evaluate, without reference to semantic content or input payload, a plurality of geometric indicators of the cognitive substrate to produce a composite assessment of whether the geometric structure of the cognitive substrate remains within admissible epistemic regimes;
issue an intrusion determination when the composite assessment satisfies a detection threshold, the intrusion determination classifying detected adversarial influence by geometric attack type;
apply, upon issuance of the intrusion determination, one or more geometric mitigation controls to affected regions of the cognitive substrate, wherein regions of the cognitive substrate not implicated in the detected adversarial influence continue normal operation throughout the mitigation period;
generate an intrusion signature encoding a structural characterization of the detected adversarial influence, wherein generating the intrusion signature does not incorporate semantic content of any input associated with the detected adversarial influence and wherein the intrusion signature is stored in a form that cannot be accessed by or incorporated into the task learning operations of the cognitive substrate; and
emit active admissibility constraints derived from the intrusion signature that restrict future cognitive trajectory selection in the cognitive substrate, wherein the emitted constraints persist independently of the mitigation controls applied upon issuance of the intrusion determination and accumulate across successive adversarial interactions such that structural immunity of the cognitive substrate against recurring geometric attack classes increases over the operational lifetime of the system.

2. The system of claim 1, wherein the cognitive substrate is decomposed into an active sector in which traversal and revisable adaptation occur, an irreversible sector comprising one or more irreversible reservoirs encoding durable knowledge, and a boundary sector mediating curvature exchange between the active sector and the irreversible sector, and wherein total curvature energy across the active sector, boundary sector, and irreversible sector changes only in response to externally introduced experience.

3. The system of claim 1, wherein the plurality of geometric indicators comprises one or more of: epistemic phase accumulation along cognitive trajectories, holonomy integrity of path-dependent experiential structure, curvature distribution and structural imbalance across regions of the cognitive substrate, representational capacity utilization relative to intrinsic geometric limits of the cognitive substrate, and reservoir boundary stress at boundaries of one or more irreversible reservoirs of the cognitive substrate.

4. The system of claim 1, wherein evaluating the plurality of geometric indicators comprises one or more of: correlating signals across the plurality of geometric indicators, evaluating persistence of anomalous indicator values over successive monitoring cycles, and comparing current indicator values against established baseline envelopes, and wherein the detection threshold requires anomalous values in a plurality of indicators assessed together, such that no single indicator value alone is sufficient to satisfy the detection threshold.

5. The system of claim 1, wherein generating the intrusion signature comprises one or more of discarding all semantic content associated with the adversarial interaction, encoding a structural cause of the detected adversarial influence as a content-agnostic geometric representation, applying a non-invertible compression operation to the geometric representation such that the original structural cause cannot be recovered from the compressed form, and projecting the compressed representation into non-navigable storage through a non-invertible projection operation, wherein the projected intrusion signature cannot be traversed, replayed, or reconstructed into active cognition.

6. The system of claim 5, wherein generating the intrusion signature is conditioned on the detected adversarial influence satisfying a persistence threshold requiring that anomalous geometric indicators underlying the intrusion determination have been present continuously over a minimum structural period, such that transient geometric stress events that satisfy the detection threshold do not produce intrusion signatures.

7. The system of claim 1, wherein the one or more geometric mitigation controls comprise one or more of:
restricting cognitive trajectory traversal into or through geometrically compromised regions and suspending consolidation of representations in affected regions;
tightening admission criteria for new representations entering the cognitive substrate in respects corresponding to the geometric attack type of the intrusion determination;
hardening representational capacity limits to resist forced over-compression in affected regions;
reinforcing boundary energy at boundaries of affected irreversible reservoirs and strengthening corroboration requirements for boundary-crossing events in affected regions; and
suppressing or qualifying outputs derived from geometrically compromised regions and signaling elevated epistemic uncertainty in outputs derived from regions adjacent to affected regions.

8. The system of claim 1, wherein the instructions further cause the system to monitor geometric indicators of the cognitive substrate following application of the one or more geometric mitigation controls, and upon sustained return of the geometric indicators to within-envelope conditions, gradually relax the one or more geometric mitigation controls in stages with monitoring between stages, re-engaging the one or more geometric mitigation controls at a prior intensity level if geometric indicators exceed within-envelope conditions during relaxation, wherein the active admissibility constraints emitted from the intrusion signature remain in force throughout and after the relaxation of the mitigation controls.

9. The system of claim 1, wherein the instructions further cause the system to:
transmit, to one or more peer systems each maintaining a respective cognitive substrate, aggregated geometric invariant summaries derived from the plurality of geometric indicators, wherein the aggregated geometric invariant summaries do not include semantic content, cognitive trajectory detail, manifold coordinates, or model parameters of the cognitive substrate;
receive aggregated geometric invariant summaries from the one or more peer systems and incorporate the received summaries into the composite assessment as a cross-node divergence signal, wherein divergence of the geometric indicators of the cognitive substrate from peer-system baselines is sufficient to satisfy the detection threshold independent of whether any single-node indicator independently satisfies the detection threshold; and
upon peer confirmation that the intrusion signature corresponds to a geometric attack class confirmed by a threshold number of peer systems, distribute the intrusion signature as an elevated admissibility constraint to the one or more peer systems without transmitting the structural characterization underlying the intrusion signature.

10. The system of claim 1, wherein the active admissibility constraints emitted from the intrusion signature evolve over the operational lifetime of the system such that repeated confirmation of the same geometric attack class strengthens the influence of the emitted constraints, the influence of the emitted constraints diminishes in the absence of corroborating adversarial activity over a decay period, and the emitted constraints are subject to controlled relaxation upon satisfaction of geometric and temporal stability criteria without requiring external intervention.

11. A computer-implemented method for detecting and mitigating adversarial geometric influence on a persistent cognitive machine, the method comprising the steps of:
maintaining a cognitive substrate comprising a structured geometric space whose geometry persists across interactions and is reshaped by accumulated experience;
evaluating, without reference to semantic content or input payload, a plurality of geometric indicators of the cognitive substrate to produce a composite assessment of whether the geometric structure of the cognitive substrate remains within admissible epistemic regimes;
issuing an intrusion determination when the composite assessment satisfies a detection threshold, the intrusion determination classifying detected adversarial influence by geometric attack type;
applying, upon issuance of the intrusion determination, one or more geometric mitigation controls to affected regions of the cognitive substrate, wherein regions of the cognitive substrate not implicated in the detected adversarial influence continue normal operation throughout the mitigation period;
generating an intrusion signature encoding a structural characterization of the detected adversarial influence, wherein generating the intrusion signature does not incorporate semantic content of any input associated with the detected adversarial influence and wherein the intrusion signature is stored in a form that cannot be accessed by or incorporated into the task learning operations of the cognitive substrate; and
emitting active admissibility constraints derived from the intrusion signature that restrict future cognitive trajectory selection in the cognitive substrate, wherein the emitted constraints persist independently of the mitigation controls applied upon issuance of the intrusion determination and accumulate across successive adversarial interactions such that structural immunity of the cognitive substrate against recurring geometric attack classes increases over the operational lifetime of the system.

12. The method of claim 11, wherein the cognitive substrate is decomposed into an active sector in which traversal and revisable adaptation occur, an irreversible sector comprising one or more irreversible reservoirs encoding durable knowledge, and a boundary sector mediating curvature exchange between the active sector and the irreversible sector, and wherein total curvature energy across the active sector, boundary sector, and irreversible sector changes only in response to externally introduced experience.

13. The method of claim 11, wherein the plurality of geometric indicators comprises one or more of: epistemic phase accumulation along cognitive trajectories, holonomy integrity of path-dependent experiential structure, curvature distribution and structural imbalance across regions of the cognitive substrate, representational capacity utilization relative to intrinsic geometric limits of the cognitive substrate, and reservoir boundary stress at boundaries of one or more irreversible reservoirs of the cognitive substrate.

14. The method of claim 11, wherein evaluating the plurality of geometric indicators comprises one or more of: correlating signals across the plurality of geometric indicators, evaluating persistence of anomalous indicator values over successive monitoring cycles, and comparing current indicator values against established baseline envelopes, and wherein the detection threshold requires anomalous values in a plurality of indicators assessed together, such that no single indicator value alone is sufficient to satisfy the detection threshold.

15. The method of claim 11, wherein generating the intrusion signature comprises discarding all semantic content associated with the adversarial interaction, encoding a structural cause of the detected adversarial influence as a content-agnostic geometric representation, applying a non-invertible compression operation to the geometric representation such that the original structural cause cannot be recovered from the compressed form, and projecting the compressed representation into non-navigable storage through a non-invertible projection operation, wherein the projected intrusion signature cannot be traversed, replayed, or reconstructed into active cognition.

16. The method of claim 15, wherein generating the intrusion signature is conditioned on the detected adversarial influence satisfying a persistence threshold requiring that anomalous geometric indicators underlying the intrusion determination have been present continuously over a minimum structural period, such that transient geometric stress events that satisfy the detection threshold do not produce intrusion signatures.

17. The method of claim 11, wherein the one or more geometric mitigation controls comprise one or more of:
restricting cognitive trajectory traversal into or through geometrically compromised regions and suspending consolidation of representations in affected regions;
tightening admission criteria for new representations entering the cognitive substrate in respects corresponding to the geometric attack type of the intrusion determination;
hardening representational capacity limits to resist forced over-compression in affected regions;
reinforcing boundary energy at boundaries of affected irreversible reservoirs and strengthening corroboration requirements for boundary-crossing events in affected regions; and
suppressing or qualifying outputs derived from geometrically compromised regions and signaling elevated epistemic uncertainty in outputs derived from regions adjacent to affected regions.

18. The method of claim 11, further comprising monitoring geometric indicators of the cognitive substrate following application of the one or more geometric mitigation controls, and upon sustained return of the geometric indicators to within-envelope conditions, gradually relaxing the one or more geometric mitigation controls in stages with monitoring between stages, re-engaging the one or more geometric mitigation controls at a prior intensity level if geometric indicators exceed within-envelope conditions during relaxation, wherein the active admissibility constraints emitted from the intrusion signature remain in force throughout and after the relaxation of the mitigation controls.

19. The method of claim 11, further comprising:
transmitting, to one or more peer systems each maintaining a respective cognitive substrate, aggregated geometric invariant summaries derived from the plurality of geometric indicators, wherein the aggregated geometric invariant summaries do not include semantic content, cognitive trajectory detail, manifold coordinates, or model parameters of the cognitive substrate;
receiving aggregated geometric invariant summaries from the one or more peer systems and incorporating the received summaries into the composite assessment as a cross-node divergence signal, wherein divergence of the geometric indicators of the cognitive substrate from peer-system baselines is sufficient to satisfy the detection threshold independent of whether any single-node indicator independently satisfies the detection threshold; and
upon peer confirmation that the intrusion signature corresponds to a geometric attack class confirmed by a threshold number of peer systems, distributing the intrusion signature as an elevated admissibility constraint to the one or more peer systems without transmitting the structural characterization underlying the intrusion signature.

20. The method of claim 11, wherein the active admissibility constraints emitted from the intrusion signature evolve over the operational lifetime of the system such that repeated confirmation of the same geometric attack class strengthens the influence of the emitted constraints, the influence of the emitted constraints diminishes in the absence of corroborating adversarial activity over a decay period, and the emitted constraints are subject to controlled relaxation upon satisfaction of geometric and temporal stability criteria without requiring external intervention.
